(19) United States
(12) Patent Application Publication
(10) Pub. No.: US 2026/0024409 A1
(43) Pub. Date: Jan. 22, 2026

(54) CASHLESS TICKET VOUCHER REDEMPTION PRIZE OPPORTUNITIES

(71) Applicant: IGT, Las Vegas, NV (US)

(72) Inventors: Yan Ha, Reno, NV (US); Dwayne Nelson, Las Vegas, NV (US)

(21) Appl. No.: 18/775,771

(22) Filed: Jul. 17, 2024

(51) Int. Cl. G07F 17/32

(52) U.S. Cl. CPC G07F 17/3258

(57) ABSTRACT

Systems and methods that enable one or more opportunities to win a prize based on an amount of pool funded via the redemption of cashless ticket vouchers.

### BACKGROUND

In various embodiments, the systems and methods of the present disclosure enable one or more opportunities to win a prize based on an amount of pool funded via the redemption of cashless ticket vouchers.

Gaming machines may provide players awards in primary games. Gaming machines generally require the player to place or make at least a minimum wager to activate the primary or base game. The award may be based on the player obtaining a winning symbol or symbol combination and on the amount of the wager placed.

### BRIEF DESCRIPTION OF THE FIGURES

FIG. 1 is a front view of an example user interface enabling a user to exchange the amount of a redeemed ticket voucher for an opportunity to win a prize.

FIG. 2 is a flow chart of an example process for operating a system which includes enabling a user at a ticket voucher redemption kiosk to exchange the amount of funds associated with a redeemed ticket voucher for an opportunity to win a progressive award.

FIG. 3 is a flow chart of an example process for operating a system which includes enabling a user at a ticket voucher redemption kiosk to exchange the amount of funds associated with a redeemed ticket voucher for an opportunity to win a prize.

FIG. 4 is a flow chart of an example process for operating a system which includes enabling a user to exchange an amount of a credit meter of a gaming device for an opportunity to win a progressive award.

FIG. 5 is a flow chart of an example process for operating a system which includes enabling a user at a ticket voucher redemption kiosk to exchange the amount of funds associated with a redeemed ticket voucher for an opportunity to win a prize.

FIG. 6 is a flow chart of an example process for operating a system which includes enabling a user at a ticket voucher redemption kiosk to exchange the amount of funds associated with a redeemed ticket voucher for an opportunity to win a prize maintained by a prize host.

FIG. 7 is a flow chart of an example process for operating a system which includes enabling a user to exchange the amount of funds associated with a credit meter of a gaming device for an opportunity to win a prize.

FIG. 8 is a schematic block diagram of one embodiment of an electronic configuration of an example gaming device of the present disclosure.

FIGS. 9A and 9B are perspective views of example alternative embodiments of the electronic gaming machines of the present disclosure.

FIG. 9C is a front view of an example personal gaming device of the present disclosure.

### DETAILED DESCRIPTION

In various embodiments, the systems and methods of the present disclosure enable one or more opportunities to win a prize based on an amount of pool funded via the redemption of cashless ticket vouchers.

In certain embodiments, in association with a user redeeming a cashless ticket voucher (e.g., an anonymous bearer instrument associated with an amount of funds) at a ticket voucher redemption kiosk, upon a determination that the amount of funds associated with the ticket voucher is less than a threshold amount, such as less than $1.00, the system of the present disclosure enables a redemption of part or all of the amount of the cashless ticket voucher in exchange for one or more award opportunities. Put differently, upon an occurrence of a ticket voucher redemption award opportunity event (e.g., a determination that a cashless ticket voucher being redeemed at a ticket voucher redemption kiosk is eligible), the system enables part or all of the amount of funds of the cashless ticket voucher to be forfeited for a chance to win an award. For example, in certain instances in which an amount of funds associated with a cashless ticket voucher is less than the requisite amount which certain users deem worthwhile to redeem, the system offers the opportunity to deposit or otherwise transfer part or all of the amount of the cashless ticket voucher to one or more progressive awards for one or more chances to win part or all of such progressive awards. In this example, the probabilities of such chances materializing into winning part or all of one or more progressive awards is based on the amount deposited such that the more a user contributes to a progressive award from a ticket voucher redemption kiosk via the redemption of a cashless ticket voucher correlates to an increased probability of winning one or more progressive awards from the amounts of such redeemed cashless ticket vouchers. Accordingly, rather than potentially burdening users with relatively small amounts of cash from the redemption of one or more cashless ticket vouchers, the systems and methods of the present disclosure enable such users to bypass being provided such small amounts of cash and rather convert the funds for one or more chances to win awards, such as progressive awards and prizes, otherwise not available to such users.

In certain additional or alternative embodiments, in association with an input to cashout a balance of a credit meter of a gaming device, such as an electronic gaming machine (“EGM”), upon a determination that the amount of funds to be cashed out from the balance of the credit meter of the gaming device is less than a threshold amount, the system enables a redemption of part or all of the amount of funds to be cashed out in exchange for one or more award opportunities. In these embodiments, upon an occurrence of a credit meter cashout award opportunity event (e.g., a determination that a balance of a credit meter of an EGM to be cashed out is eligible), the system enables part or all of the balance of the credit meter to be forfeited for a chance to win an award. For example, in certain instances in which a balance of a credit meter of an EGM is less than the amount of funds certain users deem worthwhile to be cashed out to a cashless ticket voucher for redemption at a ticket voucher redemption kiosk, the system offers the opportunity to deposit or otherwise transfer the balance of the credit meter to one or more progressive awards for one or more chances to win part or all of such progressive awards. In this example, the probabilities of such chances materializing into winning part or all of one or more progressive awards is based on the amount deposited to such progressive awards such that the more a user contributes from an EGM as part of a cashout sequence, the greater the probability of winning one or more awards from the amounts of such forfeited credit meter balances. Accordingly, rather than potentially burdening users with relatively small value ticket vouchers (that in turn need to be redeemed for cash at a ticket voucher redemption kiosk), the systems and methods of the present disclosure enable such users to bypass being provided such ticket vouchers and rather convert the funds for one or more chances to win awards, such as progressive awards and prizes, otherwise not available to such users.

More specifically, it should be appreciated that one recognized problem encountered by gaming establishment patrons often arises when the balance of a credit meter of a gaming device, such as an EGM, is below a minimum wager amount needed for a play of the wagering game. When this occurs, the user generally has limited choices or options.

One choice or option is for the user to add more money to the gaming device such that the balance of the credit meter equals or exceeds the minimum wager amount, thereby enabling the user to place the minimum wager on a play of the game. However, certain users do not have the time for additional game play at the gaming device (and/or prefer to stay within strict budgets) and thus this option is not realistic for certain users.

Another choice or option is for the user to cash out the balance of the credit meter to a cashless ticket voucher. However, since the value of the cashless ticket voucher will typically be relatively low in this situation (due to the balance of the credit meter being less than the minimum wager amount), the relatively low value cashless ticket voucher presents additional problems for a user. In certain instances, after receiving the cashless ticket voucher, the user has to: (a) locate a ticket voucher redemption kiosk, (b) wait in line, and (c) wait while the ticket voucher redemption kiosk provides the amount of funds of the cashless ticket voucher to the user. However, many users consider this process of redeeming relatively low-value ticket vouchers a waste of time and a bother while many gaming establishments would prefer dedicating resources associated with the redemption of such relatively low-value cashless ticket vouchers elsewhere. For example, given the personnel resources in processing the relatively low-value cashless ticket voucher for payment and then reconciling the relatively low value cashless ticket voucher for accounting purposes, the material resources in printing out the relatively low value cashless ticket voucher, and/or the power resources in using a ticket voucher redemption kiosk to redeem such a relatively low value cashless ticket voucher, many gaming establishments consider the handling of relatively low value cashless ticket vouchers burdensome.

In certain other instances, since certain ticket voucher redemption kiosks lack the necessary change to dispense for the relatively low value ticket voucher (e.g., a cashless ticket voucher for $0.15 may not even be able to be paid out if a ticket voucher redemption kiosk lacks access to pennies and nickels), the user needs to retain the cashless ticket voucher until additional cashless ticket vouchers are obtained and a bulk redemption of multiple cashless ticket vouchers occurs. However, if the user does not plan on undertaking any additional activity that may result in an additional cashless ticket voucher, the held relatively low value cashless ticket voucher may be lost by the user or otherwise discarded.

In view of the various recognized problems with the situation that often arises with relatively low value cashless ticket voucher and/or when a balance of a credit meter of a gaming device to be cashed out is below a threshold value (such as below the minimum amount needed to place a wager of any type at the gaming device), the system of the present disclosure enables a user the option to exchange the relatively low value cashless ticket voucher and/or the amount of the credit meter of the gaming device (to be cashed out for a relatively low value cashless ticket voucher) for one or more chances to win an award, such as a progressive award, or a prize, such as a prize having a value that corresponds to a value of a contribution pool. That is, when confronted with a relatively low value cashless ticket voucher and/or an amount of a credit meter of a gaming device that, for certain users and gaming establishments, represent unnecessary resources to handle, the system enables the relatively low value cashless ticket voucher and/or the balance of the credit meter of the gaming device to be irrevocably deposited into an escrow or contribution pool. In exchange for such an irrevocable deposit, the system provides the user a quantity of chances to win an award at least partially funded by the escrow or pool Such a configuration avoids users having to unnecessarily put additional funds on a gaming device, avoids users and gaming establishments having to handle relatively low value cashless ticket vouchers and offers users additional chances to win awards, such a progressive awards and prizes, that otherwise would not be available to them.

While certain embodiments of the present disclosure are directed to redeeming, at a ticket voucher redemption kiosk, part or all of a relatively low value cashless ticket voucher (e.g., a cashless ticket voucher associated with a value less than a threshold value, such as less than $1.00) for one or more chances to win an award, other embodiments are directed to redeeming, at a ticket voucher redemption kiosk, a non-relatively low value cashless ticket voucher (e.g., a cashless ticket voucher associated with a value at least equal to a threshold value) for one or more chances to win an award. In certain embodiments, the system enables a redemption, at a ticket voucher redemption kiosk, of certain cashless ticket vouchers (e.g., a cashless ticket voucher associated with a value at least equal to a threshold value but less than a maximum value) for one or more chances to win an award. In certain embodiments, the system enables a redemption, at a ticket voucher redemption kiosk, of any cashless ticket voucher for one or more chances to win an award. It should be further appreciated that while described as exchanging part or all of a cashless ticket voucher received at a ticket voucher redemption kiosk for a chance to win an award, such as progressive award or a prize, the system additionally or alternatively enables any suitable device operable to redeem a ticket voucher taking a physical or virtual form, such as, but not limited to, a mobile device executing an application, and/or a gaming device, to offer the exchange of part or all of a cashless ticket voucher for a chance to win an award, such as a progressive award or a prize.

While certain embodiments of the present disclosure are directed to redeeming, in association with a cashout at a gaming device, part or all of an amount of a credit meter of the gaming device that is less than a minimum wager amount for one or more chances to win an award, other embodiments are directed to redeeming, in association with a cashout at a gaming device, part or all of an amount of a credit meter of the gaming device that is at least equal to a minimum wager amount for one or more chances to win an award determined independent of the gaming device. In certain such embodiments, the system enables a redemption, in association with a cashout at a gaming device, of part or all of an amount of a credit meter of the gaming device that is at least equal to a minimum wager amount and less than a maximum wager amount for one or more chances to win an award determined independent of the gaming device. In certain other embodiments, the system enables a redemption, in association with a cashout at a gaming device, of part or all of an amount of a credit meter of a gaming device that is at least equal to a maximum wager amount for one or more chances to win an award determined independent of the gaming device. For example, if the balance of a credit meter of a gaming device is $3.25 and a minimum wager for a play of a game at the gaming device is $1.00, the system enables an operator to configure the threshold to be $5.00 such that the $3.25 is eligible to be exchanged for one or more chances to win an award determined independent of the gaming device.

It should be further appreciated that a gaming device employed in association with a redemption, as part of a cashout sequence, of part or all of an amount of a credit meter for one or more chances to win an award may be any suitable personal gaming device, such as a mobile device executing an application, any suitable EGM (such as a slot machine, a video poker machine, a video lottery terminal, a terminal associated with an electronic table game, a sporting event wagering terminal, a video keno machine, or a video bingo machine) which enables a player to play one or more games of chances, one or more games of skill (or partial skill), and/or place one or more sporting event wagers); any suitable component of a gaming establishment management system, such as a slot machine interface board (“SMIB”) which is in communication with an EGM; and/or any suitable combination of a server that operates with a personal gaming device, an EGM, and/or a component of a gaming establishment management system (e.g., a SMIB associated with an EGM) to enable a player to play one or more games of chances, one or more games of skill (or partial skill), and/or place one or more sporting event wagers.

In various embodiments, following an attempted redemption of a cashless ticket voucher at a ticket voucher redemption kiosk, the system determines whether a ticket voucher redemption award opportunity event occurred. In certain embodiments, the system determines, based on the amount of the ticket voucher to be redeemed, whether or not to offer an opportunity to win an award in association with the redemption of that ticket voucher. In certain such embodiments, the ticket voucher redemption award opportunity event occurs when an amount associated with the ticket voucher received by the ticket voucher redemption kiosk is below a threshold amount. In certain embodiments, the system additionally determines if ticket voucher redemption award opportunity event occurs responsive to a user input. In certain such embodiments, the system enables any user to make one or more inputs to cause a ticket voucher redemption award opportunity event to occur. In certain embodiments, the system enables any identified user, such as a user identified via a player tracking system, to make one or more inputs to cause a ticket voucher redemption award opportunity event to occur (wherein non-identified users cannot make such inputs to cause a ticket voucher redemption award opportunity event to occur). In certain embodiments, the system enables certain identified users, such as a user identified via a player tracking system whom has a player tracking status above a threshold status, to make one or more inputs to cause a ticket voucher redemption award opportunity event to occur (wherein non-identified users and identified users with a player tracking status below the threshold status cannot make such inputs to cause a ticket voucher redemption award opportunity event to occur). In certain embodiments, the system enables any user associated with a gaming establishment mobile device application (and/or gaming establishment account, such as a cashless wagering account) to make one or more inputs to cause a ticket voucher redemption award opportunity event to occur (wherein users not associated with the gaming establishment mobile device application (and/or the gaming establishment account) cannot make such inputs to cause a ticket voucher redemption award opportunity event to occur.

In certain embodiments, in addition to (or alternative from) determining if a ticket voucher redemption award opportunity event occurs based on an amount associated with the ticket voucher received by the ticket voucher redemption kiosk, the ticket voucher redemption award opportunity event occurs in association with any aspect of a user's experience at the ticket voucher redemption kiosk, any aspect of a user's gaming experience at one or more gaming devices (which are tracked by the system and associated with the ticket voucher at issuance) and/or any aspect of a user's non-gaming experience at one or more gaming devices (which are tracked by the system and associated with the ticket voucher at issuance).

In certain embodiments, if the system determines that no ticket voucher redemption award opportunity event occurred, the system proceeds to operate with a component of a ticket voucher system to redeem the ticket voucher in exchange for the amount of funds associated with the ticket voucher. In these embodiments, the redemption of the ticket voucher occurs at the ticket voucher redemption kiosk without enabling the amount of the ticket voucher to be exchanged for one or more chances to win an award. On the other hand, if the system determines that a ticket voucher redemption award opportunity event occurred in association with the attempted redemption of a ticket voucher, the system enables part or all of the amount associated with the ticket voucher received by the ticket voucher redemption kiosk to be exchanged for one or more chances to win an award. That is, rather than potentially frustrating the user by providing them a relatively small amount of funds from redeeming a relatively low value cashless ticket voucher (which is associated with inefficient resource allocation by the gaming establishment), the system enables the user to elect to forgo the amount of the redeemed ticket voucher for an opportunity to win one or more awards.

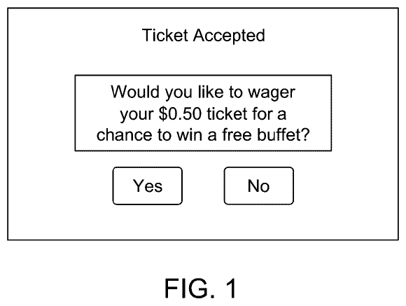

In certain embodiments, if a ticket voucher redemption award opportunity event occurred, the system enables the user at the ticket voucher redemption kiosk to make one or more inputs to contribute the amount of the ticket voucher in exchange for one or more chances to win one or more awards. For example, as seen in FIG. 1, following receipt of a ticket voucher, the ticket voucher redemption kiosk displays a prompt to the user which enables the user to decide whether or not they want to contribute the $0.50 value of their ticket voucher for a chance to win a prize of a ticket to a gaming establishment buffet. In different embodiments, the system utilizes the ticket voucher redemption kiosk, a mobile device running a mobile device application, a web browser, the gaming device, a service window displayed by the gaming device (e.g., a remote host controlled service window displayed by an EGM), a component of a gaming establishment patron management system, such as a player tracking unit, and/or a gaming establishment interface to enable a user to indicate whether to contribute the amount of the ticket voucher in exchange for one or more chances to win one or more awards.

In certain embodiments, if the user makes one or more inputs to contribute the amount of the ticket voucher, the system proceeds with the contribution of the amount of the ticket voucher and the issuance of one or more chances to win one or more awards. In these embodiments, following a ticket voucher redemption award opportunity event to determine if the amount of the ticket voucher is eligible to be contributed in exchange for one or more chances to win one or more awards, a ticket voucher redemption contribution event may occur (based on the receipt of user inputs) that results in the contribution of the amount of the ticket voucher. On the other hand, if no inputs are received, the system does not contribute the amount of the ticket voucher in exchange for one or more chances to win one or more awards (i.e., no ticket voucher redemption contribution event occurs) and rather proceeds to operate with a component of a ticket voucher system to provide the user the amount of funds associated with the ticket voucher.

In certain embodiments, if a ticket voucher redemption award opportunity event occurred, the system automatically contributes the amount of the ticket voucher in exchange for one or more chances to win one or more awards. In these embodiments, the occurrence of a ticket voucher redemption award opportunity event automatically causes an occurrence of a ticket voucher redemption contribution event. In certain such embodiments, this automatic contribution occurs following the user opting in to enabling this feature (or alternatively opting out of disabling this feature).

In certain embodiments, if the user elects (or the system automatically elects) to participate in the exchange of the amount of the ticket voucher for one or more chances to win an award (i.e., both a ticket voucher redemption award opportunity event and a ticket voucher redemption contribution event occurred), the system contributes the amount of the ticket voucher to a progressive award that grows in value as more amounts are contributed.

In certain embodiments, following the determination to exchange an amount of a ticket voucher for a chance to win an award, such as a progressive award or a prize, the system updates one or more databases to reflect the redemption of the ticket voucher for such an opportunity. That is, following the determination to exchange an amount of a ticket voucher for a chance to win an award, the system causes the ticket voucher to be designated as redeemed without causing an amount of the ticket voucher to be paid out to the user. In certain embodiments, the system operates with a ticket voucher system including one or more servers which store, in one or more databases, ticket voucher identification information associated with each ticket voucher created by the ticket voucher system, such as identifying information, value information, and/or activity information. In certain embodiments, each ticket voucher includes or is otherwise associated with different identifying information which is identifiable to a holder of the ticket voucher, such as a ticket voucher validation number, and an amount of funds associated with the ticket voucher. In different embodiments, the ticket voucher database and/or the ticket voucher includes or is otherwise associated with various fields of ticket voucher identifying information including, but not limited to: (i) a primary key (i.e., an index for a record in a table); (ii) a ticket voucher validation number (i.e., the validation number associated with the issued ticket); (iii) a ticket state (e.g., a state of a ticket as being in an issued state, a redeemed for an amount state or a redeemed for a chance to win an award state); (iv) an issuance date/time (i.e., the date/time when the ticket voucher was issued); (v) a property address associated with the ticket voucher issuance; (vi) an amount of funds associated with the ticket voucher; (vii) any expiration date associated with the ticket voucher; (viii) a device identification associated with the issuance of the ticket voucher; (ix) an image of the ticket voucher (e.g., an image of a front of the ticket voucher and/or an image of a back of the ticket voucher); (x) any redemption date (i.e., the date the ticket voucher was redeemed at (if the ticket voucher is in the redeemed state)); (xi) redeemed at (i.e., the device where the ticket voucher was redeemed (if the ticket voucher is in the redeemed state)); (xii) a data signature (i.e., a signature of the data associated with the ticket voucher to prevent tampering by casino employees); (xiii) a machine identification (i.e., an asset or machine number of the device that printed the ticket voucher); (xiv) any exchange or forfeiture of that ticket voucher for an opportunity to win one or more awards or prizes; (xv) any award triggering events associated with the ticket voucher following an exchange or forfeiture of that ticket voucher for an opportunity to win one or more awards or prizes; and/or (xvi) any awards or prizes realized from an award triggering event associated with the ticket voucher.

In certain embodiments in which the identity of the user at the ticket voucher redemption kiosk is known, the system records the user's contribution in association with an identifier of that user. In these embodiments, the system stores, for each identified user, each individual contribution to the progressive award (including, but not limited to, an amount of the contribution, a time of the contribution, a ticket voucher redemption kiosk at which the contribution was made) and a total contribution to the progressive award made by that user.

In various embodiments, in addition to (or alternative from) enabling a user at a ticket voucher redemption kiosk to exchange a ticket voucher for a chance to win one or more awards, the system enables a user at a gaming device, such as an EGM, to exchange an amount of a credit meter for a chance to win one or more awards independent of any award determinations made by the gaming device in association with any plays of any games wagerable upon at the gaming device. In these embodiments, following an establishment of a balance of a credit meter of a gaming device and zero, one or more activities that modify the balance of the credit meter, the system determines whether a credit meter cashout award opportunity event occurred. In certain embodiments, the credit meter cashout award opportunity event occurs when a cashout input is received by the gaming device when the credit meter that is below a threshold amount, such as a minimum wager amount. In certain embodiments, the credit meter cashout award opportunity event occurs when a cashout input is received by the gaming device when the credit meter is below a threshold amount, such as a minimum wager amount, and has been below that threshold amount for a designated period of time.

In certain embodiments, the system additionally or alternatively determines if credit meter cashout award opportunity event occurs responsive to a user input that is in addition to the cashout input received. In certain such embodiments, the system enables any user to make one or more inputs to cause a credit meter cashout award opportunity event to occur. In certain embodiments, the system enables any identified user, such as a user identified via a player tracking system, to make one or more inputs to cause a credit meter cashout award opportunity event to occur (wherein non-identified users cannot make such inputs to cause a credit meter cashout award opportunity event to occur). In certain embodiments, the system enables certain identified users, such as a user identified via a player tracking system whom has a player tracking status above a threshold status, to make one or more inputs to cause a credit meter cashout award opportunity event to occur (wherein non-identified users and identified users with a player tracking status below the threshold status cannot make such inputs to cause a credit meter cashout award opportunity event to occur). In certain embodiments, the system enables any user associated with a gaming establishment mobile device application (and/or gaming establishment account, such as a cashless wagering account) to make one or more inputs to cause a credit meter cashout award opportunity event to occur (wherein users not associated with the gaming establishment mobile device application (and/or the gaming establishment account) cannot make such inputs to cause a credit meter cashout award opportunity event to occur.

In certain embodiments, in addition to (or alternative from) determining if a credit meter cashout award opportunity event occurs based on an amount of a credit balance of the gaming device when the cashout input is received, the system determines if a credit meter cashout award opportunity event occurs based on an amount of wagering activity at the gaming device prior to the cashout input. In certain such embodiments, the system determines that a credit meter cashout award opportunity event occurs if at least a certain amount of wagering activity occurred at the gaming device prior to the cashout input (and the system determines that no credit meter cashout award opportunity event occurred if less than that amount of wagering activity occurred at the gaming device prior to the cashout input). In one such embodiment, the system determines that a credit meter cashout award opportunity event occurs if at least a certain amount of wagers were placed at the gaming device prior to the cashout input (and the system determines that no credit meter cashout award opportunity event occurred if less than that amount of wagers were placed at the gaming device prior to the cashout input). In another such embodiment, the system determines that a credit meter cashout award opportunity event occurs if at an average wager amount of at least a threshold amount was placed at the gaming device prior to the cashout input (and the system determines that no credit meter cashout award opportunity event occurred if the average wager amount was less than the threshold amount prior to the cashout input). In another such embodiment, the system determines that a credit meter cashout award opportunity event occurs if at least a certain number of games were played at the gaming device prior to the cashout input (and the system determines that no credit meter cashout award opportunity event occurred if less than that number of games were played at the gaming device prior to the cashout input). In another such embodiment, the system determines that a credit meter cashout award opportunity event occurs if at least a certain amount was won at the gaming device prior to the cashout input (and the system determines that no credit meter cashout award opportunity event occurred if less than that amount was won at the gaming device prior to the cashout input). In another such embodiment, the system determines that a credit meter cashout award opportunity event occurs if at least a certain amount was lost at the gaming device prior to the cashout input (and the system determines that no credit meter cashout award opportunity event occurred if less than that amount was lost at the gaming device prior to the cashout input). In another such embodiment, the system determines that a credit meter cashout award opportunity event occurs if at least a certain amount of game outcomes were generated at the gaming device prior to the cashout input (and the system determines that no credit meter cashout award opportunity event occurred if less than that amount of game outcomes were generated at the gaming device prior to the cashout input).

In certain embodiments, in addition to (or alternative from) determining if a credit meter cashout award opportunity event occurs based on an amount of a credit balance of the gaming device when a cashout input is received by the gaming device, the credit meter cashout award opportunity event occurs in association with any aspect of a user's gaming experience at a gaming device and/or any aspect of a user's non-gaming experience at a gaming device. That is, the credit meter cashout award opportunity event may occur in association with any aspect of any game of chance, any game of skill, any lottery game, or any sporting event wagering activity or may occur independent of any aspect of any game of chance, any game of skill, any lottery game or any sporting event wagering activity.

In certain embodiments, if the system determines that no credit meter cashout award opportunity event occurred in association with a cashout input being received by the gaming device, the system proceeds to operate with a component of a ticket voucher system to issue a ticket voucher for the balance of the credit meter without enabling the amount of the credit meter to be exchanged for one or more chances to win an award. On the other hand, if the system determines that a credit meter cashout award opportunity event occurred in association with a cashout input being received by the gaming device, the system enables the amount of the credit meter to be exchanged for one or more chances to win an award, such as a progressive award. That is, rather than potentially frustrating the user by issuing a relatively low value cashless ticket voucher (which is associated with inefficient resource allocation by the gaming establishment), the system enables the user to elect to forgo the amount of the credit meter for an opportunity to win one or more awards.

In certain embodiments, if a credit meter cashout award opportunity event occurred, the system enables the user at the gaming device to make one or more inputs to contribute the amount of the credit meter in exchange for one or more chances to win one or more awards. In different embodiments, the system utilizes the gaming device, an externally controlled interface displayed by the gaming device (e.g., a remote host controlled service window displayed by an EGM), a component of a gaming establishment patron management system, such as a player tracking unit, a mobile device running a mobile device application, a kiosk, a web browser, and/or a gaming establishment interface to enable the user to indicate whether to contribute the amount of the credit meter in exchange for one or more chances to win one or more awards.

In certain embodiments, if the user makes one or more inputs to contribute the amount of the credit meter, the system proceeds with the contribution of the amount of the credit meter and the issuance of one or more chances to win one or more awards. In these embodiments, following a credit meter cashout award opportunity event to determine if the amount of the to-be cashed out credit meter is eligible to be contributed in exchange for one or more chances to win one or more awards, a credit meter cashout contribution event may occur (based on the receipt of user inputs) that results in the contribution of the amount of the credit meter. On the other hand, if no inputs are received, the system does not contribute the amount of the credit meter in exchange for one or more chances to win one or more awards (i.e., no credit meter cashout contribution event occurs) and rather proceeds to operate with a component of a ticket voucher system to issue a ticket voucher for the balance of the credit meter.

In certain embodiments, if a credit meter cashout award opportunity event occurred, the system automatically contributes the amount of the credit meter in exchange for one or more chances to win one or more awards. In these embodiments, the occurrence of a credit meter cashout award opportunity event automatically causes an occurrence of a credit meter cashout contribution event. In certain such embodiments, this automatic contribution occurs following the user opting in to enabling this feature (or alternatively opting out of disabling this feature).

In certain embodiments, if the user elects (or the system automatically elects) to participate in the exchange of the amount of the to-be cashed out credit meter for one or more chances to win an award determined independent of the gaming device (i.e., both a credit meter cashout award opportunity event and a credit meter cashout contribution event occurred), the system contributes the amount of the credit meter to a progressive award that grows in value as more amounts are contributed.

In certain embodiments in which the identity of the user at the gaming device is known, the system records the user's contribution in association with an identifier of that user. In these embodiments, the system stores, for each identified user, each individual contribution to the progressive award (including, but not limited to, an amount of the contribution, a time of the contribution, a gaming device at which the contribution was made) and a total contribution to the progressive award made by that player. For example, following a user, such as a player, logged into the system, a cashout input being received at a gaming device and the user electing to contribute the amount of the credit meter in exchange for one or more chances to win one or more awards, the system maintains, in a database, such information memorializing the contribution.

In certain embodiments in which a progressive award is at least partially funded via an amount associated with a ticket voucher received by a ticket voucher redemption kiosk and/or an amount of a to-be cashed out credit meter of a gaming device, the progressive award is associated with a gaming establishment such that one or more signs throughout the gaming establishment, one or more display devices of one or more gaming devices and/or one or more display device of one or more mobile devices not operating as gaming devices display the current progressive award. In certain other embodiments, the progressive award is associated with a virtual casino such that one or more display devices of computing devices that access the virtual casino display the current progressive award. In certain of these embodiments, the value of the progressive award is displayed and visible to each user (or certain qualifying users, such as users of a certain player tracking status or users whom access the progressive award via a gaming establishment mobile device application). In other of these embodiments, the value of the progressive award is hidden and not otherwise displayed to one or more users.

In certain embodiments in which a progressive award is at least partially funded via an amount associated with a ticket voucher received by a ticket voucher redemption kiosk and/or an amount of a to-be cashed out credit meter of a gaming device, the system maintains a single progressive award which amounts of a credit meter are contributed to. In certain such embodiments, the progressive award which amounts from ticket vouchers and/or to-be cashed out credit meters are contributed to is a stand-alone progressive award associated with a single device, such as a single EGM or a single ticket voucher redemption kiosk. In certain other embodiments, the progressive award which amounts from ticket vouchers and/or to-be cashed out credit meters are contributed to is associated with a plurality of devices, such as a plurality of EGMs, a plurality of ticket voucher redemption kiosks or a combination of EGMs and ticket voucher redemption kiosks. In certain embodiments, the progressive award is part of a plurality of progressive awards maintained in an multiple-level progressive award configuration associated with a plurality of gaming devices, such as a plurality of EGMs and/or a plurality of ticket voucher redemption kiosks. In different embodiments wherein the progressive award contributed to is associated with a plurality of gaming devices and/or ticket voucher redemption kiosks, the gaming devices and/or ticket voucher redemption kiosks may be in (or otherwise associated with) a single gaming establishment (such that the progressive award may be considered a local area progressive award) or the gaming devices and/or the ticket voucher redemption kiosks may be in (or otherwise associated with) two or more different gaming establishments (such that the progressive award may be considered a wide area progressive award).

In certain embodiments in which a progressive award is at least partially funded via an amount associated with a ticket voucher received by a ticket voucher redemption kiosk and/or an amount of a to-be cashed out credit meter of a gaming device, the system maintains a plurality of progressive awards which amounts from ticket vouchers and/or to-be cashed out credit meters are contributed to. In certain such embodiments, different progressive awards contributed to from ticket vouchers and/or to-be cashed out credit meters are associated with different attributes, such as different progressive awards for different contribution amounts, different progressive awards for different statuses of a user (e.g., player tracking account statuses), different progressive awards for different attributes of a gaming device, a ticket voucher redemption kiosk, and/or a ticket voucher issued from a gaming device (e.g., different progressive awards for different denominations, different progressive awards for different device locations, different progressive awards for different contribution locations, different progressive awards for different game themes, and/or different progressive awards for different game configurations). In certain embodiments, which progressive award an amount associated with a ticket voucher and/or an amount of a credit meter is contributed to is based on one or more factors, such as, but not limited to, an amount contributed, an amount of the progressive award, an identity of a user, a status of a user (e.g., a player tracking status), an attribute of the gaming device, an attribute of the ticket voucher redemption kiosk, an attribute of the ticket voucher, wagering activity that occurred at the gaming device (as reported by the gaming device or associated with a ticket voucher issued from the gaming device), and/or non-wagering activity that occurred at the gaming device (as reported by the gaming device or associated with a ticket voucher issued from the gaming device).

In certain embodiments in which the system maintains a plurality of progressive awards which amounts from ticket vouchers and/or to-be cashed out credit meters are contributed to, different contribution amounts are associated with different progressive awards. In these embodiments, the amount contributed determines which of a plurality progressive awards a user is provided an opportunity to win. For example, a $0.25 ticket redemption is associated with an eligibility to potentially win a first level progressive award of a multi-level progressive award configuration while a $0.50 ticket redemption is associated with an eligibility to potentially win a second level progressive award of the multi-level progressive award configuration

In certain embodiments, the progressive award is associated with a contribution rate that represents, in certain instances, the portion of each contribution made that is allocated to the progressive award. In certain embodiments, the contribution rate is 100% such that the entire amount exchanged is contributed to the progressive award. In certain embodiments, the contribution rate is less than 100% such that a portion of, but not all of, the amount exchanged is contributed to the progressive award. In certain embodiments wherein the system maintains a plurality of progressive awards, each of the progressive awards maintained have the same contribution rate. In certain embodiments wherein the system maintains a plurality of progressive awards, two or more of the progressive awards have different contribution rates.

In certain embodiments, the progressive award is associated with a reset value utilized following an award triggering event. In certain embodiments wherein the system maintains a plurality of progressive awards, each of the progressive awards maintained by the system have the same progressive award reset value. In certain embodiments wherein the system maintains a plurality of progressive awards, two or more of the progressive awards maintained by the system have different progressive award reset values.

In certain embodiments, the progressive award is associated with a range of values, wherein the low end of the range of values represents the reset value of the progressive award and the high end of the range of values represents the maximum amount which the progressive award may reach. In these embodiments, the amount which the progressive award may be incremented to is capped or limited by the highest value in the value range associated with such progressive award. In these embodiments, the system determines a progressive award hit value from the value range associated with the progressive award and displays the current value of the progressive award and/or the maximum amount which the progressive award may reach. In other embodiments, the progressive award is not associated with any range of values. In this embodiment, the progressive award continues to be incremented until an award triggering event occurs.

In addition to contributing amounts of to-be cashed out credit meters to one or more progressive awards and/or contributing amounts associated with redeemed cashless ticket vouchers to one or more progressive awards, for each progressive award, the system determines if an award triggering event, such as a progressive award triggering event, occurred in association with that progressive award. In certain embodiments, an award triggering event occurs based on one or more displayed events associated with one or more plays of one or more games. In certain embodiments, an award triggering event occurs independent of any displayed events associated with any plays of any games.

If the system determines that no award triggering event occurred, the system awaits an occurrence of the award triggering event while periodically contributing zero, one or more amounts of zero, one or more to-be cashed out credit meters and/or redeemed cashless ticket vouchers. On the other hand, if the system determines that an award triggering event occurred, the system causes the current value of the progressive award to be provided to one or more users. That is, upon an occurrence of an award triggering event, the system proceeds with providing a user the progressive award. For example, following the system determining which user to provide a progressive award, the system operates with a gaming device, with a SMIB associated with a gaming device, and/or with a ticket voucher redemption kiosk to make part or all of the progressive award available to that user.

In certain embodiments in which an award triggering event occurs based on the current value of a progressive award reaching a progressive award hit value, such as a randomly determined progressive award hit value, then following the contribution of the amount which caused the current value of the progressive award to increase such that the now current value of the progressive award has reached the progressive award hit value, the system determines that the award triggering event occurred and causes the progressive award to be made available to the user associated with that contribution. In another embodiment in which an award triggering event occurs based on the current value of the progressive award reaching a progressive award hit value, following the contribution of the amount which caused the current value of the progressive award to increase such that the now current value of the progressive award has reached the progressive award hit value, the system determines that the award triggering event occurs in association with the next contribution and causes the progressive award to be made available to the user associated with that next contribution.

It should be appreciated that in these embodiments, since the determination of the award triggering event and the selection of the user that won the progressive award occur relatively immediately following the contribution to the progressive award, the system can provide the progressive award to the user at the gaming device and/or the ticket voucher redemption kiosk that made the winning contribution without otherwise needing an identity of that user. That is, since the determination to provide a progressive award to a specific user occurs with the user's decision to contribute an amount to a progressive award (and the user is still at the gaming device and/or the ticket voucher redemption kiosk), this embodiment enables anonymous users to win such progressive awards.

In certain embodiments, the system selects a user to win the progressive award based on an amount that user contributed to the progressive award and/or when the user contributed an amount to the progressive award. For example, the system assigns the odds of winning the progressive award to each user proportional to each user's relative contribution such that different users whom contribute different amounts have different probabilities of being selected to win the progressive award. In certain embodiments, in determining the relative odds of each user to win the progressive award, the system accounts for one or more additional factors, such as, but not limited to, an amount of the progressive award, an identity of a user, a status of a user (e.g., a player tracking status), an attribute of the gaming device, an attribute of a ticket voucher redemption kiosk, wagering activity that occurred at the gaming device, and/or non-wagering activity that occurred at the gaming device or the ticket voucher redemption kiosk.

In certain embodiment, upon an occurrence of an award triggering event, the system selects a user to win the progressive award independent of the amount that user contributed to the progressive award. That is, the system assigns equal odds of winning the progressive award to each user that contributed any amount to the progressive award such that different users whom contribute different amounts to the progressive award have the same probability of being selected to win the progressive award.

In certain embodiments in which the identity of the user whom contributed to the progressive award is known, the system records the odds of winning the progressive award assigned to that user in association with an identifier of that user. In these embodiments, as the system updates the odds of the user winning the progressive award (based on additional contributions by that user or contributions from other users), the system stores such information for when the award triggering event occurs.

In certain embodiments in which the system assigns odds of winning the progressive award to each user that contributed to the progressive award, the system employs a drawing to determine which users wins the progressive award upon an occurrence of an award triggering event. Such a drawing may occur live at a gaming establishment with gaming establishment personnel picking winning numbers or digitally in association with the system picking winning numbers and notifying users of the results of the drawing. In certain embodiments, responsive to a contribution of an amount to the progressive award, the system provides one or more tickets for a drawing to be held to determine which user wins a progressive award. In certain such embodiments, the quantity of tickets for the drawing provided is based on the amount contributed to the progressive award. For example, for every ten cents deposited from a redeemed relatively low valued cashless ticket voucher, the system issues a drawing ticket, such as a physical drawing ticket or a virtual drawing ticket accessible by a gaming establishment mobile device application being run by a mobile device. In another such embodiment, the system iteratively issues numbers of a single drawing ticket to a user such that each time a user deposits an amount, the system issues part of the number of the drawing ticket. For example, if the number associated with a drawing ticket is an twelve digit number and each contribution of an amount to the progressive award results in a single digit number being issued, after twelve separate contributions, an entire drawing ticket is formed and the system issues such a drawing ticket, such as a physical drawing ticket or a virtual drawing ticket accessible by a gaming establishment mobile device application being run by a mobile device. In one such embodiment, the user can check their ticket to see if they won. In another such embodiment, the mobile device application notifies the user when a drawing was about to happen and/or if the user won the drawing with any of their issued drawing tickets.

In certain embodiments, the ticket voucher redemption kiosk operates to determine if the ticket voucher redemption award opportunity event, the ticket voucher redemption contribution event and the award triggering event occurred in association with the receipt of the ticket voucher. In these embodiments, if the ticket voucher redemption award opportunity event, the ticket voucher redemption contribution event and the award triggering event occurred in association with the receipt of the ticket voucher, the ticket voucher redemption kiosk operates to dispense the current amount of the progressive award or transfer, via one or more fund transfer protocols such as a slot accounting system (“SAS”) electronic funds transfer (“EFT”) protocol and/or via a SAS protocol automated funds transfer (“AFT”) protocol, the progressive award to the user.

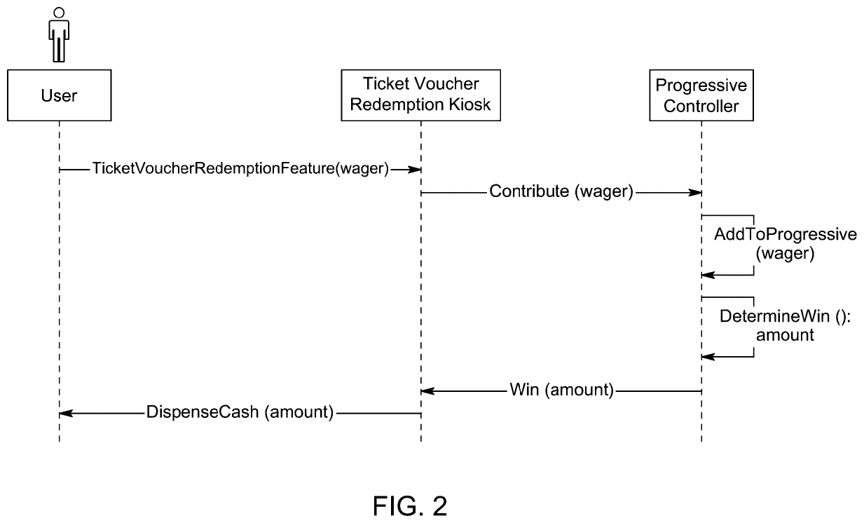

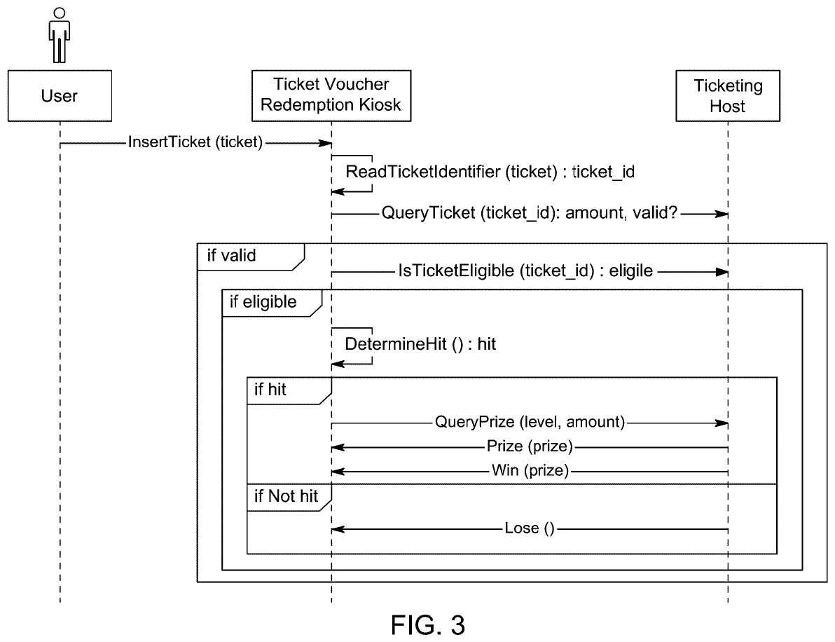

In certain embodiments, the ticket voucher redemption kiosk operates with one or more components, such as a progressive controller and/or a ticketing host, to determine if one or more of the ticket voucher redemption award opportunity event, the ticket voucher redemption contribution event and/or the award triggering event occurred in association with the receipt of the ticket voucher. In these embodiments, if the ticket voucher redemption award opportunity event, the ticket voucher redemption contribution event and the award triggering event occurred in association with the receipt of the ticket voucher, the ticket voucher redemption kiosk operates over one or more protocols (e.g., an Ethernet based protocol such as an electronic invoice presentment and payment protocol, a SAS EFT protocol and/or a SAS AFT protocol) with such components to dispense the current amount of the progressive award or transfer the progressive award to the user. For example, as seen in FIG. 2, responsive to a determination by the ticket voucher redemption kiosk that a ticket voucher redemption award opportunity event and a ticket voucher redemption contribution event occurred in association with the receipt of the ticket voucher (i.e., the user indicated they wanted to participate in the ticket voucher redemption feature), the ticket voucher redemption kiosk operates with a component that maintains a progressive award (i.e., a progressive controller) to cause a contribution of the amount of the ticket voucher to the progressive award. In this example, following the progressive controller determining that an award triggering event occurred, the progressive controller operates with the ticket voucher redemption kiosk to cause the amount of the progressive award to be provided to the user. In another example, as seen in FIG. 3, responsive to a receipt of a ticket voucher by a ticket voucher redemption kiosk, the ticket voucher redemption kiosk operates with a component of a ticket voucher management system (i.e., the ticketing host) to determine that the ticket voucher is valid and eligible to be exchanged for a chance to win a prize (i.e., the ticket voucher redemption award opportunity event and the ticket voucher redemption contribution event occurred in association with the receipt of the ticket voucher) and further to determine whether or not an award triggering event occurred to result in a prize being provided to the user.

In certain embodiments, the gaming device operates to determine if the credit meter cashout award opportunity event, the credit meter cashout contribution event and the award triggering event occurred in association with the cashout of the credit balance from the gaming device. In these embodiments, if the credit meter cashout award opportunity event, the credit meter cashout contribution event and the award triggering event occurred in association with the cashout of the credit balance of the gaming device, the gaming device operates to dispense the current amount of the progressive award or transfer, via one or more fund transfer protocols (e.g., a SAS EFT protocol and/or a SAS AFT protocol), the progressive award to the user.

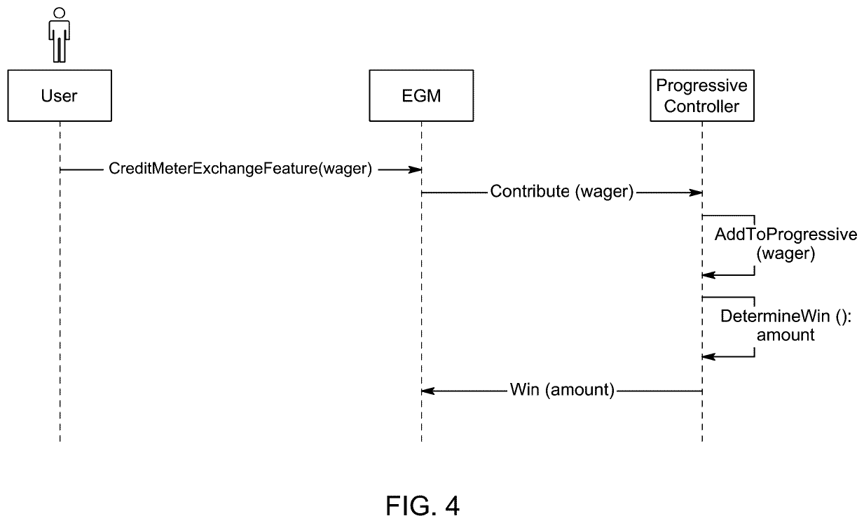

In certain embodiments, the gaming device operates with one or more components, such as a progressive controller, to determine if one or more of the credit meter cashout award opportunity event, the credit meter cashout contribution event and/or the award triggering event occurred in association with the cashout of the credit balance of the gaming device. In these embodiments, if the credit meter cashout award opportunity event, the credit meter cashout contribution event and the award triggering event occurred in association with the cashout of the credit balance of the gaming device, the gaming device operates over one or more protocols (e.g., a SAS EFT protocol and/or a SAS AFT protocol) with such components to dispense the current amount of the progressive award or transfer the progressive award to the user. For example, as seen in FIG. 4, responsive to a determination by the EGM that a credit meter cashout award opportunity event and a credit meter cashout contribution event occurred in association with the cashing out of a credit meter of the EGM (i.e., the user indicated they wanted to participate in the credit meter exchange feature), the EGM operates with a component that maintains the progressive award (i.e., the progressive controller) to cause a contribution of the amount of the credit meter to the progressive award. In this example, following the progressive controller determining that an award triggering event occurred, the progressive controller operates with the EGM to cause the amount of the progressive award to be provided to the user.

In certain embodiments, the system offers this feature to identified users whom may be subsequently notified of winning one or more progressive awards. In one such embodiment, the system requires that users have a gaming establishment account, such as a cashless wagering account, to participate in the feature such that if a progressive award is subsequently won by that user, the system contributes the amount of the progressive award into the gaming establishment account of the user. In another such embodiment, the system requires that users have a gaming establishment patron management account, such as a player tracking account, to participate in the feature such that if a progressive award is subsequently won by that user (and the user is not currently logged into the gaming establishment patron management system from a gaming device), the system escrows the amount of the progressive award in association with the gaming establishment patron management system account. In this embodiment, the next time the user logs into the gaming establishment patron management system, the system provides the escrowed progressive award to the user.

It should be appreciated that while described as providing the progressive award as an amount, such as a quantity of monetary credits, in different embodiments, one or more progressive awards may take the form of one or more of: a quantity of non-monetary credits, a quantity of promotional credits, a quantity of player tracking points, a modifier, such as a multiplier, one or more comps, such as a free dinner, a free night's stay at a hotel, a high value product such as a free car, one or more bonus credits usable for online play, a multiplier for player tracking points or credits, an increase in a membership or player tracking level, one or more coupons or promotions usable within and/or outside of the gaming establishment (e.g., a 20% off coupon for use at a convenience store), virtual goods associated with the system, virtual goods independent of the system, an access code usable to unlock content on an internet.

In certain embodiments, if a user is selected to win a progressive award, the system employs part or all of the amount of the progressive award to purchase lottery tickets for the user selected to win the progressive award. In certain other embodiments, if a user is selected to win a progressive award, the system employs part or all of the amount of the progressive award to make sporting event wagers for the user selected to win the progressive award. In certain other embodiments, if a user is selected to win a progressive award, the system employs part or all of the amount of the progressive award to make wagers on games of chance (and/or games of skill) for the user selected to win the progressive award. In these different embodiments, following a determination of a user selected to win a progressive award at one point in time, such lottery tickets and/or wagers are placed at a later point in time when such lottery tickets and/or wagers become available to be procured.

In certain such embodiments, rather than providing the user the progressive award as an amount, the system provides the user the progressive award as a prize. In these embodiments, after contributing to a progressive award and being selected to win that progressive award, the system employs the current value of the progressive award (or the partial value of the progressive award won by the user) to determine a prize for the user. For example, if the system selects a user to win a progressive award valued at $75, the system determines a prize also valued at $75 and the system causes such a prize to become available to the user. In certain embodiments, the system determines, based on an identity of the user and the amount of the progressive award, which prize to provide to the user. For example, if the system selects a user to win a progressive award valued at $500, the system determines that five different prizes are valued at (or within a designated range of) $500 and the system determines, based on one or more attributes of the user or determined preferences of the user, which of the five prizes to make available to the user. In certain embodiments, the system associates the prize with an account of the user. In certain other embodiments, the system causes the gaming device or ticket voucher redemption kiosk to dispense a ticket which represents the physical prize. In these embodiments, the user goes to a customer service desk and receives the prize.

In certain embodiments, the system determines, based on an amount of the progressive award and zero, one or more additional factors, which prize to provide in association with an occurrence of an award triggering event. In certain embodiments, the system determines a plurality of prizes available based on an amount of the progressive award and enables a user to select which prize to provide in association with an occurrence of an award triggering event.

In certain embodiments, the system enables an operator to enter information associated with one or more available prizes and associate a value or odds of hitting the prize. For example, an operator enters the available prize of buffet tickets and notes that there are fifty such prizes available. In this example, the operator indicates that there is a 1 in 1,000 chance of winning the buffet ticket such that the system associates a 1 in 1,000 chance of an award triggering event occurring in association with winning the buffet ticket. In another example, the operator enters a value of the buffet ticket, such as $25. In this example, when a user contributes a ticket voucher having a value of $0.50 for a chance to win the buffet ticket, the system determines whether or not an award triggering event occurs by picking fifty random numbers (i.e., one random number for each $0.01 contributed) and determining whether any of the fifty random numbers caused the award triggering event to occur.

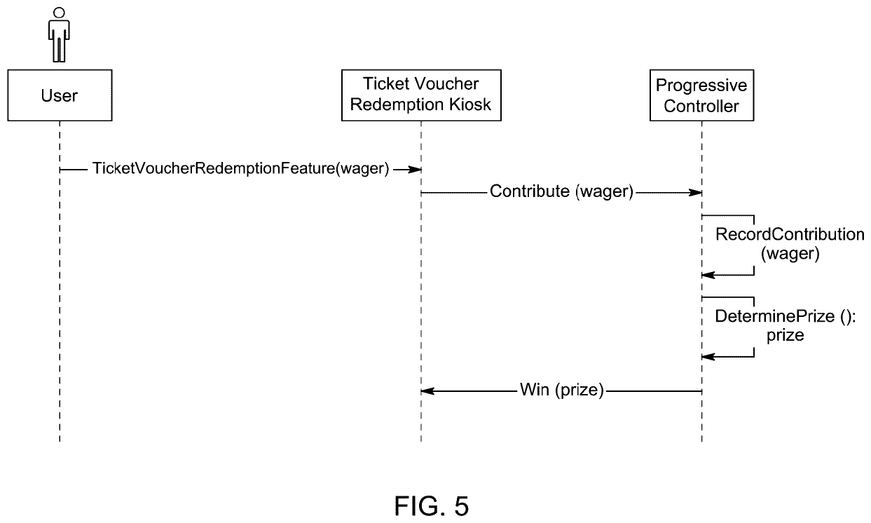

In certain embodiments in which the award takes the form of a non-monetary prize, the ticket voucher redemption kiosk operates with one or more components, such as a progressive controller and/or prize host, to determine if one or more of the ticket voucher redemption award opportunity event, the ticket voucher redemption contribution event and/or the award triggering event occurred in association with the receipt of the ticket voucher and/or to determine which prize to make available to the user. In certain such embodiments, if the ticket voucher redemption award opportunity event, the ticket voucher redemption contribution event and the award triggering event occurred in association with the receipt of the ticket voucher, the ticket voucher redemption kiosk operates with a progressive controller to determine a prize. For example, as seen in FIG. 5, responsive to a determination by the ticket voucher redemption kiosk that a ticket voucher redemption award opportunity event and a ticket voucher redemption contribution event occurred in association with the receipt of the ticket voucher, the ticket voucher redemption kiosk operates with a progressive controller to cause a contribution of the amount of the ticket voucher to the progressive award. In this example, following an occurrence of the award triggering event, the progressive controller causes a prize (which, in this instance, correlates to the amount of the progressive award) to be made available to the user.

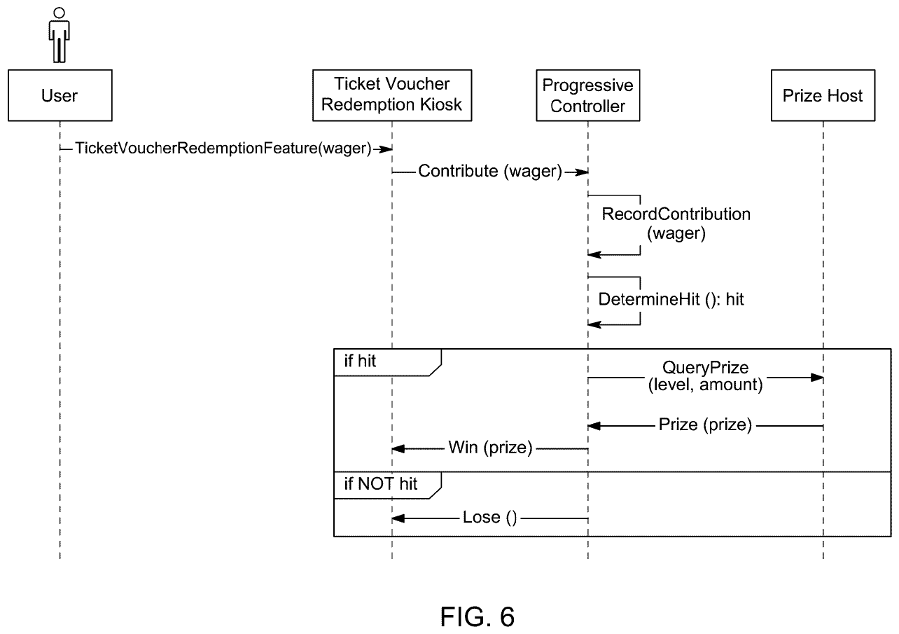

In another example, as seen in FIG. 6, responsive to a determination by the ticket voucher redemption kiosk that a ticket voucher redemption award opportunity event and a ticket voucher redemption contribution event occurred in association with the receipt of the ticket voucher, the ticket voucher redemption kiosk operates with a progressive controller to cause a contribution of the amount of the ticket voucher to the progressive award. In this example, following a determination by the progressive controller of an occurrence of the award triggering event, the progressive controller operates with a prize host to determine a prize (which, in this instance, correlates to the amount of the progressive award) and causes that determined prize to be made available to the user. Specifically, in this example, if the progressive controller determines the contribution of the amount of the redeemed ticket voucher is a winner, the progressive controller queries the prize host to learn the name or other identifier of the prize (which may be maintained by the prize via an operator entering the names, descriptions and values of the available prizes). Such a configuration includes the progressive controller providing an amount of the progressive award to the prize host such that the prize host matches a prize to the amount. Alternatively if the progressive controller determines the contribution of the amount of the redeemed ticket voucher is a winner, the progressive controller queries the prize host for a listing of all prizes available and the progressive controller employs such a listing to determine a prize that matches to the amount of the progressive award.

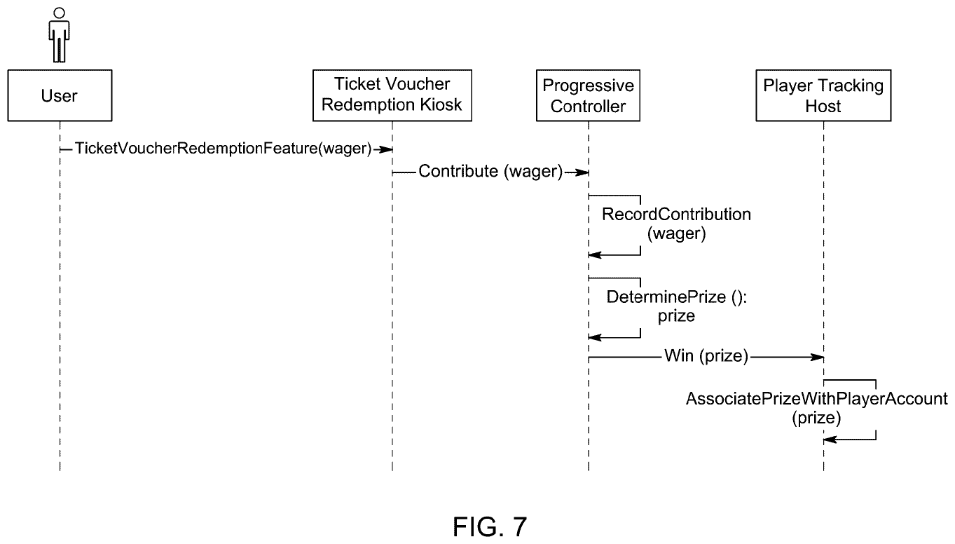

In certain embodiments in which the award takes the form of a non-monetary prize, the gaming device operates with one or more components, such as a progressive controller and/or player tracking host, to determine if one or more of the credit meter cashout award opportunity event, the credit meter cashout contribution event and/or the award triggering event occurred and/or to determine which prize to make available to the user. In certain such embodiments, if the credit meter cashout award opportunity event, the credit meter cashout contribution event and the award triggering event occurred, the gaming device operates with a progressive controller and a component of a player tracking system to determine a prize which correlates to an amount of a contribution pool. For example, as seen in FIG. 7, responsive to a determination by the gaming device that a credit meter cashout award opportunity event and a credit meter cashout contribution event occurred, the gaming device operates with a progressive controller to cause a contribution of the amount of the credit meter to the progressive award. In this example, following a determination by the progressive controller of an occurrence of the award triggering event, the progressive controller operates to determine a prize (which correlates to the amount of the progressive award) and notifies a component of a player tracking system (i.e., the player tracking host) to associate that determined prize with the user. Specifically, if the progressive controller determines the contribution of the amount of the credit meter is a winner, the progressive controller matches a prize to the amount won by the user and alerts the player tracking host to associate the won prize with an account of the user. In this example, the user can go to a service desk to retrieve the prize, the gaming establishment (or a third-party prize redemption service engaged by the gaming establishment) can mail the prize to the user or the gaming establishment emails/texts a link to the user to redeem the prize.

It should be appreciated that while generally described as a progressive award being provided to a specific player, such a progressive award may additionally or alternatively be provided to a group of users. For example, upon an award triggering event, an amount of the progressive award is divided amongst multiple players who each contributed to the progressive award. In different examples, the amount could be split equally amongst the winners or follow some pay scale (e.g., first, second and third prizes that are each a different percentage of the progressive award).

Accordingly and in view of the various recognized problems with the situation that often arises with relatively low value cashless ticket voucher and/or when a balance of a credit meter of a gaming device to be cashed out is below a threshold value (such as below the minimum amount needed to place a wager of any type at the gaming device), the system of the present disclosure enables a user the option to exchange the relatively low value cashless ticket voucher and/or the amount of the credit meter of the gaming device (to be cashed out for a relatively low value cashless ticket voucher) for one or more chances to win an award, such as a progressive award or a prize having a value that corresponds to the value of a contribution pool. That is, when confronted with a relatively low value cashless ticket voucher and/or an amount of a credit meter of a gaming device that, for certain users and gaming establishments, represent unnecessary resources to handle, the system enables the relatively low value cashless ticket voucher and/or the balance of the credit meter of the gaming device to be irrevocably deposited into an escrow or pool. In exchange for such an irrevocable deposit, the system provides the user a quantity of chances to win an award at least partially funded by the escrow or pool Such a configuration avoids users having to unnecessarily put additional funds on a gaming device, avoids users and gaming establishments having to handle relatively low value cashless ticket vouchers and offers users additional chances to win awards, such a progressive awards and/or prizes, that otherwise would not be available to them.

In different embodiments, a credit meter cashout award opportunity event, a ticket voucher redemption award opportunity event, a credit meter cashout contribution event, a ticket voucher redemption contribution event, and/or an award triggering event occurs based on an outcome associated with one or more plays of any games. In one embodiment, such determinations are symbol driven based on the generation of one or more designated symbols or symbol combinations. In various embodiments, a generation of a designated symbol (or sub-symbol) or a designated set of symbols (or sub-symbols) over one or more plays of a primary game causes such conditions to be satisfied and/or one or more of such events to occur.

In different embodiments, the system does not provide any apparent reasons to the players for an occurrence of a credit meter cashout award opportunity event, a ticket voucher redemption award opportunity event, a credit meter cashout contribution event, a ticket voucher redemption contribution event, and/or an award triggering event. In these embodiments, such determinations are not triggered by an event in a game or based specifically on any of the plays of any games. That is, these events occur without any explanation or alternatively with simple explanations.

In one such embodiment, a credit meter cashout award opportunity event, a ticket voucher redemption award opportunity event, a credit meter cashout contribution event, a ticket voucher redemption contribution event, and/or an award triggering event occurs based on an amount of coin-in. In this embodiment, the system determines if an amount of coin-in reaches or exceeds a designated amount of coin-in (i.e., a threshold coin-in amount). Upon the amount of coin-in wagered reaching or exceeding the threshold coin-in amount, the system causes one or more of such events or conditions to occur. In another such embodiment, a credit meter cashout award opportunity event, a ticket voucher redemption award opportunity event, a credit meter cashout contribution event, a ticket voucher redemption contribution event, and/or an award triggering event occurs based on an amount of virtual currency-in. In this embodiment, the system determines if an amount of virtual currency-in wagered reaches or exceeds a designated amount of virtual currency-in (i.e., a threshold virtual currency-in amount). Upon the amount of virtual currency-in wagered reaching or exceeding the threshold virtual currency-in amount, the system causes one or more of such events or conditions to occur. In different embodiments, the threshold coin-in amount and/or the threshold virtual currency-in amount is predetermined, randomly determined, determined based on a player's status (such as determined through a player tracking system), determined based on a generated symbol or symbol combination, determined based on a random determination by the central controller, determined based on a random determination at the gaming device, determined based on one or more side wagers placed, determined based on the player's primary game wager, determined based on time (such as the time of day) or determined based on any other suitable method or criteria.

In one such embodiment, a credit meter cashout award opportunity event, a ticket voucher redemption award opportunity event, a credit meter cashout contribution event, a ticket voucher redemption contribution event, and/or an award triggering event occurs based on an amount of coin-out. In this embodiment, the system determines if an amount of coin-out reaches or exceeds a designated amount of coin-out (i.e., a threshold coin-out amount). Upon the amount of coin-out reaching or exceeding the threshold coin-out amount, the system causes one or more of such events or conditions to occur. In another such embodiment, a credit meter cashout award opportunity event, a ticket voucher redemption award opportunity event, a credit meter cashout contribution event, a ticket voucher redemption contribution event, and/or an award triggering event occurs based on an amount of virtual currency-out. In this embodiment, the system determines if an amount of virtual currency-out reaches or exceeds a designated amount of virtual currency-out (i.e., a threshold virtual currency-out amount). Upon the amount of virtual currency-out reaching or exceeding the threshold virtual currency-out amount, the system causes one or more of such events or conditions to occur. In different embodiments, the threshold coin-out amount and/or the threshold virtual currency-out amount is predetermined, randomly determined, determined based on a player's status (such as determined through a player tracking system), determined based on a generated symbol or symbol combination, determined based on a random determination by the central controller, determined based on a random determination at the gaming device, determined based on one or more side wagers placed, determined based on the player's primary game wager, determined based on time (such as the time of day) or determined based on any other suitable method or criteria.

In different embodiments, a credit meter cashout award opportunity event, a ticket voucher redemption award opportunity event, a credit meter cashout contribution event, a ticket voucher redemption contribution event, and/or an award triggering event occurs based on a predefined variable reaching a defined parameter threshold. For example, when the 500,000^{th} player has played an EGM (ascertained from a player tracking system), one or more of such events or conditions occur. In different embodiments, the predefined parameter thresholds include a length of time, a length of time after a certain dollar amount is hit, a wager level threshold for a specific device (which EGM is the first to contribute $250,000), a number of EGMs active, or any other parameter that defines a suitable threshold.

In different embodiments, a credit meter cashout award opportunity event, a ticket voucher redemption award opportunity event, a credit meter cashout contribution event, a ticket voucher redemption contribution event, and/or an award triggering event occurs based on a quantity of games played. In this embodiment, a quantity of games played is set for when one or more of such events or conditions will occur. In one embodiment, such a set quantity of games played is based on historic data.

In different embodiments, a credit meter cashout award opportunity event, a ticket voucher redemption award opportunity event, a credit meter cashout contribution event, a ticket voucher redemption contribution event, and/or an award triggering event occurs based on time. In this embodiment, a time is set for when one or more of such events or conditions will occur. In one embodiment, such a set time is based on historic data.

In different embodiments, a credit meter cashout award opportunity event, a ticket voucher redemption award opportunity event, a credit meter cashout contribution event, a ticket voucher redemption contribution event, and/or an award triggering event occurs based upon system operator defined player eligibility parameters stored on a player tracking system (such as via a player tracking card or other suitable manner). In this embodiment, the parameters for eligibility are defined by the system operator based on any suitable criterion. In one embodiment, the system recognizes the player's identification (via the player tracking system) when the player inserts or otherwise associates their player tracking card in the EGM and/or logs into the player tracking system using a mobile device, such as a personal gaming device. The system determines the player tracking level of the player and if the current player tracking level defined by the system operator is eligible for one or more of such events or conditions. In one embodiment, the system operator defines minimum bet levels required for such events or conditions to occur based on the player's card level.

In different embodiments, a credit meter cashout award opportunity event, a ticket voucher redemption award opportunity event, a credit meter cashout contribution event, a ticket voucher redemption contribution event, and/or an award triggering event occurs based on a system determination, including one or more random selections by the central controller. For example, as described above, the system tracks all active EGMs and the wagers they placed, wherein based on the EGM's state as well as one or more wager pools associated with the EGM, the system determines whether to one or more of such events or conditions will occur. In one such embodiment, the player who consistently places a higher wager is more likely to be associated with an occurrence of one or more of such events or conditions than a player who consistently places a minimum wager. It should be appreciated that the criteria for determining whether a player is in active status or inactive status for determining if one or more of such events occur may the same as, substantially the same as, or different than the criteria for determining whether a player is in active status or inactive status for another one of such events to occur.

In different embodiments, a credit meter cashout award opportunity event, a ticket voucher redemption award opportunity event, a credit meter cashout contribution event, a ticket voucher redemption contribution event, and/or an award triggering event occurs based on a determination of if any numbers allotted to an EGM match a randomly selected number. In this embodiment, upon or prior to each play of each EGM, an EGM selects a random number from a range of numbers and during each primary game, the EGM allocates the first N numbers in the range, where N is the number of credits bet by the player in that primary game. At the end of the primary game, the randomly selected number is compared with the numbers allocated to the player and if a match occurs, one or more of such events or conditions occur.

It should be appreciated that any suitable manner of causing a credit meter cashout award opportunity event, a ticket voucher redemption award opportunity event, a credit meter cashout contribution event, a ticket voucher redemption contribution event, and/or an award triggering event to occur may be implemented in accordance with the system and method of the present disclosure. It should be further appreciated that one or more of the above-described triggers pertaining to a credit meter cashout award opportunity event, a ticket voucher redemption award opportunity event, a credit meter cashout contribution event, a ticket voucher redemption contribution event, and/or an award triggering event occurring may be combined in one or more different embodiments.

It should be appreciated that in different embodiments, one or more of: whether a credit meter cashout award opportunity event, a ticket voucher redemption award opportunity event, a credit meter cashout contribution event, a ticket voucher redemption contribution event, and/or an award triggering event occurs; a maximum amount of a ticket voucher contributable to a progressive award; a minimum amount of a ticket voucher contributable to a progressive award; an eligibility to participate in contributing an amount of a ticket voucher to a progressive award; any parameters of any chance to win a progressive award for forfeiting an amount of a ticket voucher; a maximum amount of a credit meter contributable to a progressive award; a minimum amount of a credit meter contributable to a progressive award; an eligibility to participate in contributing an amount of a credit meter to a progressive award; any parameters of any chance to win a progressive award for forfeiting an amount of a credit meter; and/or any determination of the present disclosure is/are predetermined, randomly determined, randomly determined based on one or more weighted percentages, determined based on a generated symbol or symbol combination, determined independent of a generated symbol or symbol combination, determined based on a random determination by the central controller, determined independent of a random determination by the central controller, determined based on a random determination at the gaming table component, determined independent of a random determination at the gaming table component, determined based on at least one play of at least one game, determined independent of at least one play of at least one game, determined based on a user's selection, determined independent of a user's selection, determined based on one or more side wagers placed, determined independent of one or more side wagers placed, determined based on the user's primary game wager, determined independent of the user's primary game wager, determined based on time (such as the time of day), determined independent of time (such as the time of day), determined based on an amount of coin-in accumulated in one or more progressive awards, determined independent of an amount of coin-in accumulated in one or more progressive awards, determined based on a status of the user (i.e., a player tracking status), determined independent of a status of the user (i.e., a player tracking status), determined based on one or more other determinations of the present disclosure, determined independent of any other determination of the present disclosure or determined based on any other suitable method or criteria.

The above-described embodiments of the present disclosure may be implemented in accordance with or in conjunction with one or more of a variety of different types of systems, such as, but not limited to, those described below. As such, the present disclosure contemplates a variety of different systems each having one or more of a plurality of different features, attributes, or characteristics. A “system” as used herein refers to various configurations of: (a) one or more servers; (b) one or more electronic gaming machines; (c) one or more ticket voucher redemption kiosks, and/or (d) one or more personal gaming devices. Thus, in various embodiments, the system of the present disclosure includes: one or more electronic gaming machines in combination with one or more servers; one or more ticket voucher redemption kiosks in combination with one or more servers; a single electronic gaming machine; a plurality of electronic gaming machines in combination with one another; a single ticket voucher redemption kiosk; a plurality of ticket voucher redemption kiosks in combination with one another; a single server; and/or a plurality of servers in combination with one another. For brevity and clarity and unless specifically stated otherwise, “EGM” as used herein represents one EGM or a plurality of EGMs, “personal gaming device” as used herein represents one personal gaming device or a plurality of personal gaming devices, “ticket voucher redemption kiosk” as used herein represents one ticket voucher redemption kiosk or a plurality of ticket voucher redemption kiosks and “server” as used herein represents one server or a plurality of servers.

As noted above, in various embodiments, the system includes an EGM or ticket voucher redemption kiosk in combination with a server. In such embodiments, the EGM or ticket voucher redemption kiosk is configured to communicate with the server through a data network or remote communication link. In certain such embodiments, the EGM or ticket voucher redemption kiosk is configured to communicate with another EGM or ticket voucher redemption kiosk through the same data network or remote communication link or through a different data network or remote communication link. For example, the system includes a plurality of EGMs that are each configured to communicate with a server through a data network.

In certain embodiments in which the system includes an EGM or ticket voucher redemption kiosk in combination with a server, the server is any suitable computing device (such as a server) that includes at least one processor and at least one memory device or data storage device. As further described herein, the EGM or ticket voucher redemption kiosk includes at least one EGM or ticket voucher redemption kiosk processor configured to transmit and receive data or signals representing events, messages, commands, or any other suitable information between the EGM or ticket voucher redemption kiosk and the server. The at least one processor of that EGM or ticket voucher redemption kiosk is configured to execute the events, messages, or commands represented by such data or signals in conjunction with the operation of the EGM or ticket voucher redemption kiosk. Moreover, the at least one processor of the server is configured to transmit and receive data or signals representing events, messages, commands, or any other suitable information between the server and the EGM or ticket voucher redemption kiosk. The at least one processor of the server is configured to execute the events, messages, or commands represented by such data or signals in conjunction with the operation of the server. One, more than one, or each of the functions of the server may be performed by the at least one processor of the EGM or ticket voucher redemption kiosk. Further, one, more than one, or each of the functions of the at least one processor of the EGM or ticket voucher redemption kiosk may be performed by the at least one processor of the server.

In certain such embodiments, computerized instructions for controlling any games (such as any primary or base games and/or any secondary or bonus games) displayed by the EGM (or personal gaming device) are executed by the server. In such “thin client” embodiments, the server remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the server to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the system includes an EGM (or personal gaming device) and a server, computerized instructions for controlling any primary or base games displayed by the EGM (or personal gaming device) are communicated from the server to the EGM (or personal gaming device) in a thick client configuration, and computerized instructions for controlling any secondary or bonus games or other functions displayed by the EGM (or personal gaming device) are executed by the server in a thin client configuration.

In certain embodiments in which the system includes: (a) an EGM or ticket voucher redemption kiosk configured to communicate with a server through a data network; and/or (b) a plurality of EGMs or ticket voucher redemption kiosks configured to communicate with one another through a data network, the data network is a local area network (LAN) in which the EGMs or ticket voucher redemption kiosks are located substantially proximate to one another and/or the server. In one example, the EGMs or ticket voucher redemption kiosks and the server are located in a gaming establishment or a portion of a gaming establishment.

In other embodiments in which the system includes: (a) an EGM or ticket voucher redemption kiosk configured to communicate with a server through a data network; and/or (b) a plurality of EGMs or ticket voucher redemption kiosks configured to communicate with one another through a data network, the data network is a wide area network (WAN) in which one or more of the EGMs or ticket voucher redemption kiosks are not necessarily located substantially proximate to another one of the EGMs or ticket voucher redemption kiosks and/or the server. For example, one or more of the EGMs or ticket voucher redemption kiosks are located: (a) in an area of a gaming establishment different from an area of the gaming establishment in which the server is located; or (b) in a gaming establishment different from the gaming establishment in which the server is located. In another example, the server is not located within a gaming establishment in which the EGMs or ticket voucher redemption kiosks are located. In certain embodiments in which the data network is a WAN, the system includes a server and an EGM or ticket voucher redemption kiosk each located in a different gaming establishment in a same geographic area, such as a same city or a same state. Systems in which the data network is a WAN are substantially identical to systems in which the data network is a LAN, though the quantity of EGMs or ticket voucher redemption kiosks in such systems may vary relative to one another.

In further embodiments in which the system includes: (a) an EGM or ticket voucher redemption kiosk configured to communicate with a server through a data network; and/or (b) a plurality of EGMs or ticket voucher redemption kiosks configured to communicate with one another through a data network, the data network is an internet (such as the Internet) or an intranet. In certain such embodiments, an Internet browser of the EGM or ticket voucher redemption kiosk is usable to access an Internet game page from any location where an Internet connection is available. In one such embodiment, after the EGM (or personal gaming device) accesses the Internet game page, the server identifies a player before enabling that player to place any wagers on any plays of any wagering games. In one example, the server identifies the player by requiring a player account of the player to be logged into via an input of a unique username and password combination assigned to the player. The server may, however, identify the player in any other suitable manner, such as by validating a player tracking identification number associated with the player; by reading a player tracking card or other smart card inserted into a card reader (as described below); by validating a unique player identification number associated with the player by the server; or by identifying the EGM (or personal gaming device), such as by identifying the MAC address or the IP address of the Internet facilitator. In various embodiments, once the server identifies the player, the server enables placement of one or more wagers on one or more plays of one or more primary or base games and/or one or more secondary or bonus games, and displays those plays via the Internet browser of the EGM (or personal gaming device).

The server and the EGM or ticket voucher redemption kiosk are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

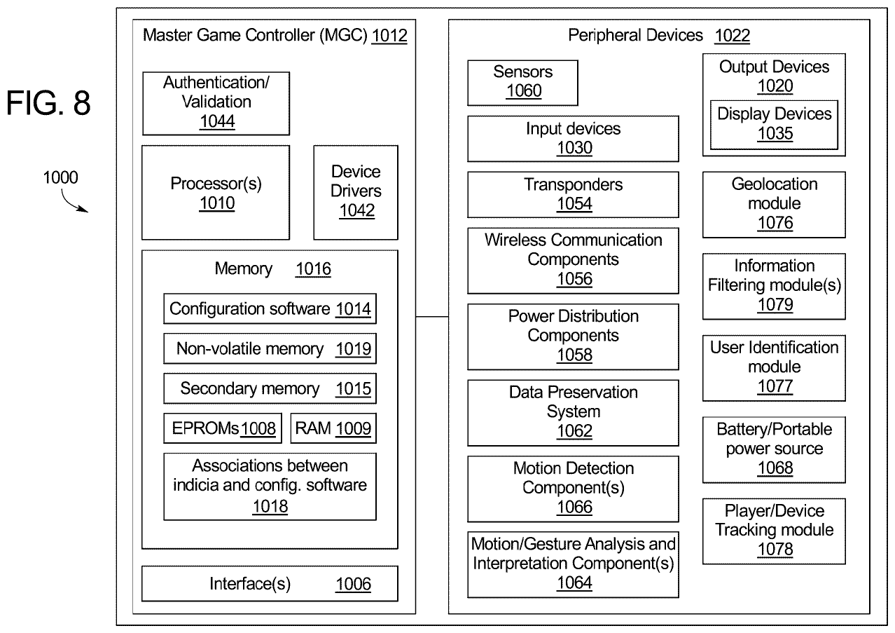

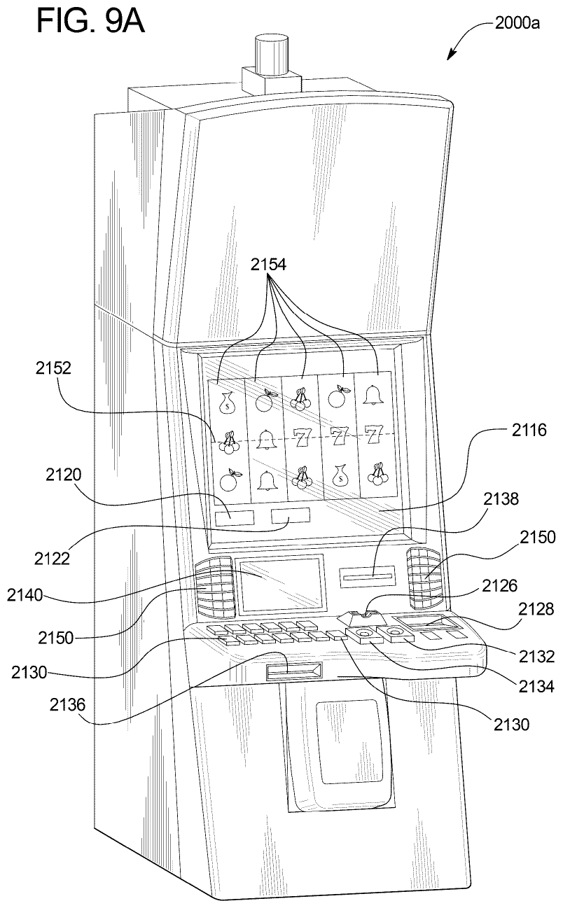

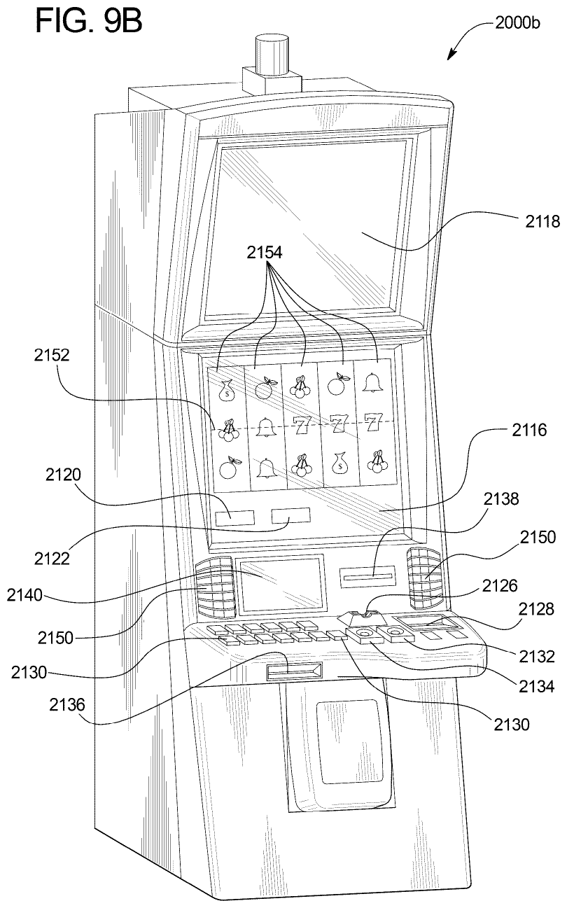

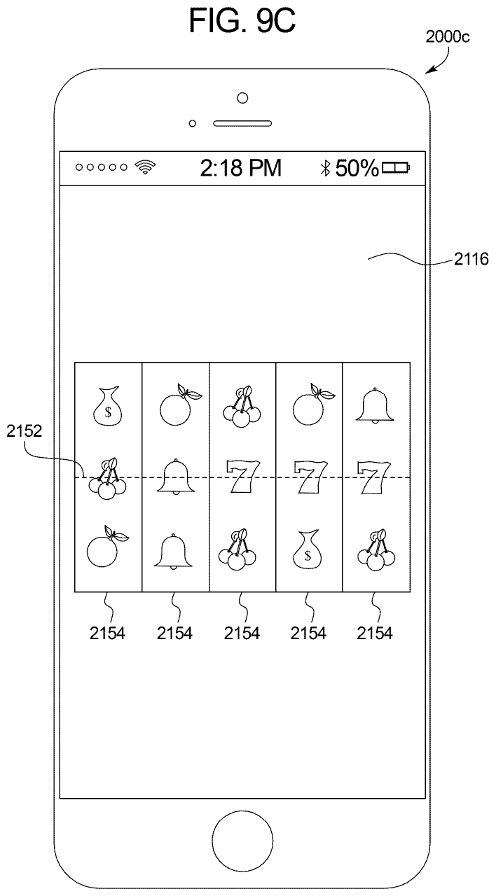

FIG. 8 is a block diagram of an example EGM 1000 and FIGS. 9A and 9B include two different example EGMs 2000a and 2000b. The EGMs 1000, 2000a, and 2000b are merely example EGMs, and different EGMs may be implemented using different combinations of the components shown in the EGMs 1000, 2000a, and 2000b. Although the below refers to EGMs, in various embodiments personal gaming devices (such as personal gaming device 2000c of FIG. 9C) may include some or all of the below components. Additionally, while the below refers to EGMs, in various embodiments, one or more ticket voucher redemption kiosks may include some or all of the below components.

In these embodiments, the EGM 1000 includes a master gaming controller 1012 configured to communicate with and to operate with a plurality of peripheral devices 1022.

The master gaming controller 1012 includes at least one processor 1010. The at least one processor 1010 is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or game information) via a communication interface 1006 of the master gaming controller 1012; (2) converting signals read by an interface to a format corresponding to that used by software or memory of the EGM; (3) accessing memory to configure or reconfigure game parameters in the memory according to indicia read from the EGM; (4) communicating with interfaces and the peripheral devices 1022 (such as input/output devices); and/or (5) controlling the peripheral devices 1022. In certain embodiments, one or more components of the master gaming controller 1012 (such as the at least one processor 1010) reside within a housing of the EGM (described below), while in other embodiments at least one component of the master gaming controller 1012 resides outside of the housing of the EGM.

The master gaming controller 1012 also includes at least one memory device 1016, which includes: (1) volatile memory (e.g., RAM 1009, which can include non-volatile RAM, magnetic RAM, ferroelectric RAM, and any other suitable forms); (2) non-volatile memory 1019 (e.g., disk memory, FLASH memory, EPROMs, EEPROMs, memristor-based non-volatile solid-state memory, etc.); (3) unalterable memory (e.g., EPROMs 1008); (4) read-only memory; and/or (5) a secondary memory storage device 1015, such as a non-volatile memory device, configured to store gaming software related information (the gaming software related information and the memory may be used to store various audio files and games not currently being used and invoked in a configuration or reconfiguration). Any other suitable magnetic, optical, and/or semiconductor memory may operate in conjunction with the EGM of the present disclosure. In certain embodiments, the at least one memory device 1016 resides within the housing of the EGM (described below), while in other embodiments at least one component of the at least one memory device 1016 resides outside of the housing of the EGM. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device 1016 is configured to store, for example: (1) configuration software 1014, such as all the parameters and settings for a game playable on the EGM; (2) associations 1018 between configuration indicia read from an EGM with one or more parameters and settings; (3) communication protocols configured to enable the at least one processor 1010 to communicate with the peripheral devices 1022; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the EGM to communicate with local and non-local devices using such protocols. In one implementation, the master gaming controller 1012 communicates with other devices using a serial communication protocol. A few non-limiting examples of serial communication protocols that other devices, such as peripherals (e.g., a bill validator or a ticket printer), may use to communicate with the master game controller 1012 include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device 1016 is configured to store program code and instructions executable by the at least one processor of the EGM to control the EGM. The at least one memory device 1016 of the EGM also stores other operating data, such as image data, event data, input data, random number generators (RNGs) or pseudo-RNGs, paytable data or information, and/or applicable game rules that relate to the play of one or more games on the EGM. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a player uses such a removable memory device in an EGM to implement at least part of the present disclosure. In other embodiments, part or all of the program code and/or the operating data is downloaded to the at least one memory device of the EGM through any suitable data network described above (such as an Internet or intranet).

The at least one memory device 1016 also stores a plurality of device drivers 1042. Examples of different types of device drivers include device drivers for EGM components and device drivers for the peripheral components 1022. Typically, the device drivers 1042 utilize various communication protocols that enable communication with a particular physical device. The device driver abstracts the hardware implementation of that device. For example, a device driver may be written for each type of card reader that could potentially be connected to the EGM. Non-limiting examples of communication protocols used to implement the device drivers include Netplex, USB, Serial, Ethernet 175, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the EGM loads the new device driver from the at least one memory device to enable communication with the new device. For instance, one type of card reader in the EGM can be replaced with a second different type of card reader when device drivers for both card readers are stored in the at least one memory device.

In certain embodiments, the software units stored in the at least one memory device 1016 can be upgraded as needed. For instance, when the at least one memory device 1016 is a hard drive, new games, new game options, new parameters, new settings for existing parameters, new settings for new parameters, new device drivers, and new communication protocols can be uploaded to the at least one memory device 1016 from the master game controller 1012 or from some other external device. As another example, when the at least one memory device 1016 includes a CD/DVD drive including a CD/DVD configured to store game options, parameters, and settings, the software stored in the at least one memory device 1016 can be upgraded by replacing a first CD/DVD with a second CD/DVD. In yet another example, when the at least one memory device 1016 uses flash memory 1019 or EPROM 1008 units configured to store games, game options, parameters, and settings, the software stored in the flash and/or EPROM memory units can be upgraded by replacing one or more memory units with new memory units that include the upgraded software. In another embodiment, one or more of the memory devices, such as the hard drive, may be employed in a game software download process from a remote software server.

In some embodiments, the at least one memory device 1016 also stores authentication and/or validation components 1044 configured to authenticate/validate specified EGM components and/or information, such as hardware components, software components, firmware components, peripheral device components, user input device components, information received from one or more user input devices, information stored in the at least one memory device 1016, etc.

In certain embodiments, the peripheral devices 1022 include several device interfaces, such as: (1) at least one output device 1020 including at least one display device 1035; (2) at least one input device 1030 (which may include contact and/or non-contact interfaces); (3) at least one transponder 1054; (4) at least one wireless communication component 1056; (5) at least one wired/wireless power distribution component 1058; (6) at least one sensor 1060; (7) at least one data preservation component 1062; (8) at least one motion/gesture analysis and interpretation component 1064; (9) at least one motion detection component 1066; (10) at least one portable power source 1068; (11) at least one geolocation module 1076; (12) at least one user identification module 1077; (13) at least one player/device tracking module 1078; and (14) at least one information filtering module 1079.

The at least one output device 1020 includes at least one display device 1035 configured to display any game(s) displayed by the EGM and any suitable information associated with such game(s). In certain embodiments, the display devices are connected to or mounted on a housing of the EGM (described below). In various embodiments, the display devices serve as digital glass configured to advertise certain games or other aspects of the gaming establishment in which the EGM is located. In various embodiments, the EGM includes one or more of the following display devices: (a) a central display device; (b) a player tracking display configured to display various information regarding a player's player tracking status (as described below); (c) a secondary or upper display device in addition to the central display device and the player tracking display; (d) a credit display configured to display a current quantity of credits, amount of cash, account balance, or the equivalent; and (e) a bet display configured to display an amount wagered for one or more plays of one or more games. The example EGM 2000a illustrated in FIG. 9A includes a central display device 2116, a player tracking display 2140, a credit display 2120, and a bet display 2122. The example EGM 2000b illustrated in FIG. 9B includes a central display device 2116, an upper display device 2118, a player tracking display 2140, a credit display 2120, and a bet display 2122.

In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

The display devices of the EGM are configured to display one or more game and/or non-game images, symbols, and indicia. In certain embodiments, the display devices of the EGM are configured to display any suitable visual representation or exhibition of the movement of objects; dynamic lighting; video images; images of people, characters, places, things, and faces of cards; and the like. In certain embodiments, the display devices of the EGM are configured to display one or more video reels, one or more video wheels, and/or one or more video dice. In other embodiments, certain of the displayed images, symbols, and indicia are in mechanical form. That is, in these embodiments, the display device includes any electromechanical device, such as one or more rotatable wheels, one or more reels, and/or one or more dice, configured to display at least one or a plurality of game or other suitable images, symbols, or indicia.

In various embodiments, the at least one output device 1020 includes a payout device. In these embodiments, after the EGM receives an actuation of a cashout device (described below), the EGM causes the payout device to provide a payment to the player. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. The example EGMs 2000a and 2000b illustrated in FIGS. 9A and 9B each include a ticket printer and dispenser 2136.

In certain embodiments, rather than dispensing bills, coins, or a physical ticket having a monetary value to the player following receipt of an actuation of the cashout device, the payout device is configured to cause a payment to be provided to the player in the form of an electronic funds transfer, such as via a direct deposit into a bank account, a casino account, or a prepaid account of the player; via a transfer of funds onto an electronically recordable identification card or smart card of the player; or via sending a virtual ticket having a monetary value to an electronic device of the player.

While any credit balances, any wagers, any values, and any awards are described herein as amounts of monetary credits or currency, one or more of such credit balances, such wagers, such values, and such awards may be for non-monetary credits, promotional credits, of player tracking points or credits.

In certain embodiments, the at least one output device 1020 is a sound generating device controlled by one or more sound cards. In one such embodiment, the sound generating device includes one or more speakers or other sound generating hardware and/or software configured to generate sounds, such as by playing music for any games or by playing music for other modes of the EGM, such as an attract mode. The example EGMs 2000a and 2000b illustrated in FIGS. 9A and 9B each include a plurality of speakers 2150. In another such embodiment, the EGM provides dynamic sounds coupled with attractive multimedia images displayed on one or more of the display devices to provide an audio-visual representation or to otherwise display full-motion video with sound to attract players to the EGM. In certain embodiments, the EGM displays a sequence of audio and/or visual attraction messages during idle periods to attract potential players to the EGM. The videos may be customized to provide any appropriate information.

The at least one input device 1030 may include any suitable device that enables an input signal to be produced and received by the at least one processor 1010 of the EGM.

In one embodiment, the at least one input device 1030 includes a payment device configured to communicate with the at least one processor of the EGM to fund the EGM. In certain embodiments, the payment device includes one or more of: (a) a bill acceptor into which paper money is inserted to fund the EGM; (b) a ticket acceptor into which a ticket or a voucher is inserted to fund the EGM; (c) a coin slot into which coins or tokens are inserted to fund the EGM; (d) a reader or a validator for credit cards, debit cards, or credit slips into which a credit card, debit card, or credit slip is inserted to fund the EGM; (e) a player identification card reader into which a player identification card is inserted to fund the EGM; or (f) any suitable combination thereof. The example EGMs 2000a and 2000b illustrated in FIGS. 9A and 9B each include a combined bill and ticket acceptor 2128 and a coin slot 2126.

In one embodiment, the at least one input device 1030 includes a payment device configured to enable the EGM to be funded via an electronic funds transfer, such as a transfer of funds from a bank account. In another embodiment, the EGM includes a payment device configured to communicate with a mobile device of a player, such as a mobile phone, a radio frequency identification tag, or any other suitable wired or wireless device, to retrieve relevant information associated with that player to fund the EGM. When the EGM is funded, the at least one processor determines the amount of funds entered and displays the corresponding amount on a credit display or any other suitable display as described below.

In certain embodiments, the at least one input device 1030 includes at least one wagering or betting device. In various embodiments, the one or more wagering or betting devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). One such wagering or betting device is as a maximum wager or bet device that, when actuated, causes the EGM to place a maximum wager on a play of a game. Another such wagering or betting device is a repeat bet device that, when actuated, causes the EGM to place a wager that is equal to the previously-placed wager on a play of a game. A further such wagering or betting device is a bet one device that, when actuated, causes the EGM to increase the wager by one credit. Generally, upon actuation of one of the wagering or betting devices, the quantity of credits displayed in a credit meter (described below) decreases by the amount of credits wagered, while the quantity of credits displayed in a bet display (described below) increases by the amount of credits wagered.

In various embodiments, the at least one input device 1030 includes at least one game play activation device. In various embodiments, the one or more game play initiation devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). After a player appropriately funds the EGM and places a wager, the EGM activates the game play activation device to enable the player to actuate the game play activation device to initiate a play of a game on the EGM (or another suitable sequence of events associated with the EGM). After the EGM receives an actuation of the game play activation device, the EGM initiates the play of the game. The example EGMs 2000a and 2000b illustrated in FIGS. 9A and 9B each include a game play activation device in the form of a game play initiation button 2132. In other embodiments, the EGM begins game play automatically upon appropriate funding rather than upon utilization of the game play activation device.

In other embodiments, the at least one input device 1030 includes a cashout device. In various embodiments, the cashout device is: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). When the EGM receives an actuation of the cashout device from a player and the player has a positive (i.e., greater-than-zero) credit balance, the EGM initiates a payout associated with the player's credit balance. The example EGMs 2000a and 2000b illustrated in FIGS. 9A and 9B each include a cashout device in the form of a cashout button 2134.

In various embodiments, the at least one input device 1030 includes a plurality of buttons that are programmable by the EGM operator to, when actuated, cause the EGM to perform particular functions. For instance, such buttons may be hard keys, programmable soft keys, or icons icon displayed on a display device of the EGM (described below) that are actuatable via a touch screen of the EGM (described below) or via use of a suitable input device of the EGM (such as a mouse or a joystick). The example EGMs 2000a and 2000b illustrated in FIGS. 9A and 9B each include a plurality of such buttons 2130.

In certain embodiments, the at least one input device 1030 includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the EGM by touching the touch screen at the appropriate locations.

In embodiments including a player tracking system, as further described below, the at least one input device 1030 includes a card reader in communication with the at least one processor of the EGM. The example EGMs 2000a and 2000b illustrated in FIGS. 9A and 9B each include a card reader 2138. The card reader is configured to read a player identification card inserted into the card reader.

The at least one wireless communication component 1056 includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component 1056 transmits electrical, electromagnetic, or optical signals that carry digital data streams or analog signals representing various types of information.

The at least one wired/wireless power distribution component 1058 includes components or devices that are configured to provide power to other devices. For example, in one embodiment, the at least one power distribution component 1058 includes a magnetic induction system that is configured to provide wireless power to one or more user input devices near the EGM. In one embodiment, a user input device docking region is provided, and includes a power distribution component that is configured to recharge a user input device without requiring metal-to-metal contact. In one embodiment, the at least one power distribution component 1058 is configured to distribute power to one or more internal components of the EGM, such as one or more rechargeable power sources (e.g., rechargeable batteries) located at the EGM.

In certain embodiments, the at least one sensor 1060 includes at least one of: optical sensors, pressure sensors, RF sensors, infrared sensors, image sensors, thermal sensors, and biometric sensors. The at least one sensor 1060 may be used for a variety of functions, such as: detecting movements and/or gestures of various objects within a predetermined proximity to the EGM; detecting the presence and/or identity of various persons (e.g., players, casino employees, etc.), devices (e.g., user input devices), and/or systems within a predetermined proximity to the EGM.

The at least one data preservation component 1062 is configured to detect or sense one or more events and/or conditions that, for example, may result in damage to the EGM and/or that may result in loss of information associated with the EGM. Additionally, the data preservation system 1062 may be operable to initiate one or more appropriate action(s) in response to the detection of such events/conditions.

The at least one motion/gesture analysis and interpretation component 1064 is configured to analyze and/or interpret information relating to detected player movements and/or gestures to determine appropriate player input information relating to the detected player movements and/or gestures. For example, in one embodiment, the at least one motion/gesture analysis and interpretation component 1064 is configured to perform one or more of the following functions: analyze the detected gross motion or gestures of a player; interpret the player's motion or gestures (e.g., in the context of a casino game being played) to identify instructions or input from the player; utilize the interpreted instructions/input to advance the game state; etc. In other embodiments, at least a portion of these additional functions may be implemented at a remote system or device.

The at least one portable power source 1068 enables the EGM to operate in a mobile environment. For example, in one embodiment, the EGM 300 includes one or more rechargeable batteries.

The at least one geolocation module 1076 is configured to acquire geolocation information from one or more remote sources and use the acquired geolocation information to determine information relating to a relative and/or absolute position of the EGM. For example, in one implementation, the at least one geolocation module 1076 is configured to receive GPS signal information for use in determining the position or location of the EGM. In another implementation, the at least one geolocation module 1076 is configured to receive multiple wireless signals from multiple remote devices (e.g., EGMs, servers, wireless access points, etc.) and use the signal information to compute position/location information relating to the position or location of the EGM.

The at least one user identification module 1077 is configured to determine the identity of the current user or current owner of the EGM. For example, in one embodiment, the current user is required to perform a login process at the EGM in order to access one or more features. Alternatively, the EGM is configured to automatically determine the identity of the current user based on one or more external signals, such as an RFID tag or badge worn by the current user and that provides a wireless signal to the EGM that is used to determine the identity of the current user. In at least one embodiment, various security features are incorporated into the EGM to prevent unauthorized users from accessing confidential or sensitive information.

The at least one information filtering module 1079 is configured to perform filtering (e.g., based on specified criteria) of selected information to be displayed at one or more displays 1035 of the EGM.

In various embodiments, the EGM includes a plurality of communication ports configured to enable the at least one processor of the EGM to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, such as the example EGMs 2000a and 2000b illustrated in FIGS. 9A and 9B, the EGM has a support structure, housing, or cabinet that provides support for a plurality of the input devices and the output devices of the EGM. Further, the EGM is configured such that a player may operate it while standing or sitting. In various embodiments, the EGM is positioned on a base or stand, or is configured as a pub-style tabletop game (not shown) that a player may operate typically while sitting. As illustrated by the different example EGMs 2000a and 2000b shown in FIGS. 9A and 9B, EGMs may have varying housing and display configurations.

In certain embodiments, the EGM is a device that has obtained approval from a regulatory gaming commission, and in other embodiments, the EGM is a device that has not obtained approval from a regulatory gaming commission.

The EGMs described above are merely three examples of different types of EGMs. Certain of these example EGMs may include one or more elements that may not be included in all systems, and these example EGMs may not include one or more elements that are included in other systems. For example, certain EGMs include a coin acceptor while others do not.

In various embodiments, an EGM may be implemented in one of a variety of different configurations. In various embodiments, the EGM may be implemented as one of: (a) a dedicated EGM in which computerized game programs executable by the EGM for controlling any primary or base games (referred to herein as “primary games”) and/or any secondary or bonus games or other functions (referred to herein as “secondary games”) displayed by the EGM are provided with the EGM before delivery to a gaming establishment or before being provided to a player; and (b) a changeable EGM in which computerized game programs executable by the EGM for controlling any primary games and/or secondary games displayed by the EGM are downloadable or otherwise transferred to the EGM through a data network or remote communication link; from a USB drive, flash memory card, or other suitable memory device; or in any other suitable manner after the EGM is physically located in a gaming establishment or after the EGM is provided to a player.

As generally explained above, in various embodiments in which the system includes a server and a changeable EGM, the at least one memory device of the server stores different game programs and instructions executable by the at least one processor of the changeable EGM to control one or more primary games and/or secondary games displayed by the changeable EGM. More specifically, each such executable game program represents a different game or a different type of game that the at least one changeable EGM is configured to operate. In one example, certain of the game programs are executable by the changeable EGM to operate games having the same or substantially the same game play but different paytables. In different embodiments, each executable game program is associated with a primary game, a secondary game, or both. In certain embodiments, an executable game program is executable by the at least one processor of the at least one changeable EGM as a secondary game to be played simultaneously with a play of a primary game (which may be downloaded to or otherwise stored on the at least one changeable EGM), or vice versa.

In operation of such embodiments, the server is configured to communicate one or more of the stored executable game programs to the at least one processor of the changeable EGM. In different embodiments, a stored executable game program is communicated or delivered to the at least one processor of the changeable EGM by: (a) embedding the executable game program in a device or a component (such as a microchip to be inserted into the changeable EGM); (b) writing the executable game program onto a disc or other media; or (c) uploading or streaming the executable game program over a data network (such as a dedicated data network). After the executable game program is communicated from the server to the changeable EGM, the at least one processor of the changeable EGM executes the executable game program to enable the primary game and/or the secondary game associated with that executable game program to be played using the display device(s) and/or the input device(s) of the changeable EGM. That is, when an executable game program is communicated to the at least one processor of the changeable EGM, the at least one processor of the changeable EGM changes the game or the type of game that may be played using the changeable EGM.

In certain embodiments, the system randomly determines any game outcome(s) (such as a win outcome) and/or award(s) (such as a quantity of credits to award for the win outcome) for a play of a primary game and/or a play of a secondary game based on probability data. In certain such embodiments, this random determination is provided through utilization of an RNG, such as a true RNG or a pseudo RNG, or any other suitable randomization process. In one such embodiment, each game outcome or award is associated with a probability, and the system generates the game outcome(s) and/or the award(s) to be provided based on the associated probabilities. In these embodiments, since the system generates game outcomes and/or awards randomly or based on one or more probability calculations, there is no certainty that the system will ever provide any specific game outcome and/or award.

In certain embodiments, the system maintains one or more predetermined pools or sets of predetermined game outcomes and/or awards. In certain such embodiments, upon generation or receipt of a game outcome and/or award request, the system independently selects one of the predetermined game outcomes and/or awards from the one or more pools or sets. The system flags or marks the selected game outcome and/or award as used. Once a game outcome or an award is flagged as used, it is prevented from further selection from its respective pool or set; that is, the system does not select that game outcome or award upon another game outcome and/or award request. The system provides the selected game outcome and/or award.

In certain embodiments, the system determines a predetermined game outcome and/or award based on the results of a bingo, keno, or lottery game. In certain such embodiments, the system utilizes one or more bingo, keno, or lottery games to determine the predetermined game outcome and/or award provided for a primary game and/or a secondary game. The system is provided or associated with a bingo card. Each bingo card consists of a matrix or array of elements, wherein each element is designated with separate indicia. After a bingo card is provided, the system randomly selects or draws a plurality of the elements. As each element is selected, a determination is made as to whether the selected element is present on the bingo card. If the selected element is present on the bingo card, that selected element on the provided bingo card is marked or flagged. This process of selecting elements and marking any selected elements on the provided bingo cards continues until one or more predetermined patterns are marked on one or more of the provided bingo cards. After one or more predetermined patterns are marked on one or more of the provided bingo cards, game outcome and/or award is determined based, at least in part, on the selected elements on the provided bingo cards.

In certain embodiments in which the system includes a server and an EGM, the EGM is configured to communicate with the server for monitoring purposes only. In such embodiments, the EGM determines the game outcome(s) and/or award(s) to be provided in any of the manners described above, and the server monitors the activities and events occurring on the EGM. In one such embodiment, the system includes a real-time or online accounting and gaming information system configured to communicate with the server. In this embodiment, the accounting and gaming information system includes: (a) a player database configured to store player profiles, (b) a player tracking module configured to track players (as described below), and (c) a credit system configured to provide automated transactions.

As noted above, in various embodiments, the system includes one or more executable game programs executable by at least one processor of the system to provide one or more primary games and one or more secondary games. The primary game(s) and the secondary game(s) may comprise any suitable games and/or wagering games, such as, but not limited to: electro-mechanical or video slot or spinning reel type games; video card games such as video draw poker, multi-hand video draw poker, other video poker games, video blackjack games, and video baccarat games; video keno games; video bingo games; and video selection games.

In certain embodiments in which the primary game is a slot or spinning reel type game, the system includes one or more reels in either an electromechanical form with mechanical rotating reels or in a video form with simulated reels and movement thereof. Each reel displays a plurality of indicia or symbols, such as bells, hearts, fruits, numbers, letters, bars, or other images that typically correspond to a theme associated with the system. In certain such embodiments, the system includes one or more paylines associated with the reels. The example EGM 2000b shown in FIG. 9B includes a payline 2152 and a plurality of reels 2154. In certain embodiments, one or more of the reels are independent reels or unisymbol reels. In such embodiments, each independent reel generates and displays one symbol.

In various embodiments, one or more of the paylines is horizontal, vertical, circular, diagonal, angled, or any suitable combination thereof. In other embodiments, each of one or more of the paylines is associated with a plurality of adjacent symbol display areas on a requisite number of adjacent reels. In one such embodiment, one or more paylines are formed between at least two symbol display areas that are adjacent to each other by either sharing a common side or sharing a common corner (i.e., such paylines are connected paylines). The system enables a wager to be placed on one or more of such paylines to activate such paylines. In other embodiments in which one or more paylines are formed between at least two adjacent symbol display areas, the system enables a wager to be placed on a plurality of symbol display areas, which activates those symbol display areas.

In various embodiments, the system provides one or more awards after a spin of the reels when specified types and/or configurations of the indicia or symbols on the reels occur on an active payline or otherwise occur in a winning pattern, occur on the requisite number of adjacent reels, and/or occur in a scatter pay arrangement.

In certain embodiments, the system employs a ways to win award determination. In these embodiments, any outcome to be provided is determined based on a number of associated symbols that are generated in active symbol display areas on the requisite number of adjacent reels (i.e., not on paylines passing through any displayed winning symbol combinations). If a winning symbol combination is generated on the reels, one award for that occurrence of the generated winning symbol combination is provided.

In various embodiments, the system includes a progressive award. Typically, a progressive award includes an initial amount and an additional amount funded through a portion of each wager placed to initiate a play of a primary game. When one or more triggering events occurs, the system provides at least a portion of the progressive award. After the system provides the progressive award, an amount of the progressive award is reset to the initial amount and a portion of each subsequent wager is allocated to the next progressive award.

As generally noted above, in addition to providing winning credits or other awards for one or more plays of the primary game(s), in various embodiments the system provides credits or other awards for one or more plays of one or more secondary games. The secondary game typically enables an award to be obtained addition to any award obtained through play of the primary game(s). The secondary game(s) typically produces a higher level of player excitement than the primary game(s) because the secondary game(s) provides a greater expectation of winning than the primary game(s) and is accompanied with more attractive or unusual features than the primary game(s). The secondary game(s) may be any type of suitable game, either similar to or completely different from the primary game.

In various embodiments, the system automatically provides or initiates the secondary game upon the occurrence of a triggering event or the satisfaction of a qualifying condition. In other embodiments, the system initiates the secondary game upon the occurrence of the triggering event or the satisfaction of the qualifying condition and upon receipt of an initiation input. In certain embodiments, the triggering event or qualifying condition is a selected outcome in the primary game(s) or a particular arrangement of one or more indicia on a display device for a play of the primary game(s), such as a “BONUS” symbol appearing on three adjacent reels along a payline following a spin of the reels for a play of the primary game. In other embodiments, the triggering event or qualifying condition occurs based on a certain amount of game play (such as number of games, number of credits, amount of time) being exceeded, or based on a specified number of points being earned during game play. Any suitable triggering event or qualifying condition or any suitable combination of a plurality of different triggering events or qualifying conditions may be employed.

In other embodiments, at least one processor of the system randomly determines when to provide one or more plays of one or more secondary games. In one such embodiment, no apparent reason is provided for providing the secondary game. In this embodiment, qualifying for a secondary game is not triggered by the occurrence of an event in any primary game or based specifically on any of the plays of any primary game. That is, qualification is provided without any explanation or, alternatively, with a simple explanation. In another such embodiment, the system determines qualification for a secondary game at least partially based on a game triggered or symbol triggered event, such as at least partially based on play of a primary game.

In various embodiments, after qualification for a secondary game has been determined, the secondary game participation may be enhanced through continued play on the primary game. Thus, in certain embodiments, for each secondary game qualifying event, such as a secondary game symbol, that is obtained, a given number of secondary game wagering points or credits is accumulated in a “secondary game meter” configured to accrue the secondary game wagering credits or entries toward eventual participation in the secondary game. In one such embodiment, the occurrence of multiple such secondary game qualifying events in the primary game results in an arithmetic or exponential increase in the number of secondary game wagering credits awarded. In another such embodiment, any extra secondary game wagering credits may be redeemed during the secondary game to extend play of the secondary game.

In certain embodiments, no separate entry fee or buy-in for the secondary game is required. That is, entry into the secondary game cannot be purchased; rather, in these embodiments entry must be won or earned through play of the primary game, thereby encouraging play of the primary game. In other embodiments, qualification for the secondary game is accomplished through a simple “buy-in.” For example, qualification through other specified activities is unsuccessful, payment of a fee or placement of an additional wager “buys-in” to the secondary game. In certain embodiments, a separate side wager must be placed on the secondary game or a wager of a designated amount must be placed on the primary game to enable qualification for the secondary game. In these embodiments, the secondary game triggering event must occur and the side wager (or designated primary game wager amount) must have been placed for the secondary game to trigger.

In various embodiments in which the system includes a plurality of EGMs, the EGMs are configured to communicate with one another to provide a group gaming environment. In certain such embodiments, the EGMs enable players of those EGMs to work in conjunction with one another, such as by enabling the players to play together as a team or group, to win one or more awards. In other such embodiments, the EGMs enable players of those EGMs to compete against one another for one or more awards. In one such embodiment, the EGMs enable the players of those EGMs to participate in one or more gaming tournaments for one or more awards.

In various embodiments, the system includes one or more player tracking systems. Such player tracking systems enable operators of the system (such as casinos or other gaming establishments) to recognize the value of customer loyalty by identifying frequent customers and rewarding them for their patronage. Such a player tracking system is configured to track a player's gaming activity. In one such embodiment, the player tracking system does so through the use of player tracking cards. In this embodiment, a player is issued a player identification card that has an encoded player identification number that uniquely identifies the player. When the player's playing tracking card is inserted into a card reader of the system to begin a gaming session, the card reader reads the player identification number off the player tracking card to identify the player. The system timely tracks any suitable information or data relating to the identified player's gaming session. The system also timely tracks when the player tracking card is removed to conclude play for that gaming session. In another embodiment, rather than requiring insertion of a player tracking card into the card reader, the system utilizes one or more portable devices, such as a mobile phone, a radio frequency identification tag, or any other suitable wireless device, to track when a gaming session begins and ends. In another embodiment, the system utilizes any suitable biometric technology or ticket technology to track when a gaming session begins and ends.

In such embodiments, during one or more gaming sessions, the system tracks any suitable information or data, such as any amounts wagered, average wager amounts, and/or the time at which these wagers are placed. In different embodiments, for one or more players, the player tracking system includes the player's account number, the player's card number, the player's first name, the player's surname, the player's preferred name, the player's player tracking ranking, any promotion status associated with the player's player tracking card, the player's address, the player's birthday, the player's anniversary, the player's recent gaming sessions, or any other suitable data. In various embodiments, such tracked information and/or any suitable feature associated with the player tracking system is displayed on a player tracking display. In various embodiments, such tracked information and/or any suitable feature associated with the player tracking system is displayed via one or more service windows that are displayed on the central display device and/or the upper display device.

In various embodiments, the system includes one or more servers configured to communicate with a personal gaming device—such as a smartphone, a tablet computer, a desktop computer, or a laptop computer—to enable web-based game play using the personal gaming device. In various embodiments, the player must first access a gaming website via an Internet browser of the personal gaming device or execute an application (commonly called an “app”) installed on the personal gaming device before the player can use the personal gaming device to participate in web-based game play. In certain embodiments, the one or more servers and the personal gaming device operate in a thin-client environment. In these embodiments, the personal gaming device receives inputs via one or more input devices (such as a touch screen and/or physical buttons), the personal gaming device sends the received inputs to the one or more servers, the one or more servers make various determinations based on the inputs and determine content to be displayed (such as a randomly determined game outcome and corresponding award), the one or more servers send the content to the personal gaming device, and the personal gaming device displays the content.

In certain such embodiments, the one or more servers must identify the player before enabling game play on the personal gaming device (or, in some embodiments, before enabling monetary wager-based game play on the personal gaming device). In these embodiments, the player must identify herself to the one or more servers, such as by inputting the player's unique username and password combination, providing an input to a biometric sensor (e.g., a fingerprint sensor, a retinal sensor, a voice sensor, or a facial-recognition sensor), or providing any other suitable information.

Once identified, the one or more servers enable the player to establish an account balance from which the player can draw credits usable to wager on plays of a game. In certain embodiments, the one or more servers enable the player to initiate an electronic funds transfer to transfer funds from a bank account to the player's account balance. In other embodiments, the one or more servers enable the player to make a payment using the player's credit card, debit card, or other suitable device to add money to the player's account balance. In other embodiments, the one or more servers enable the player to add money to the player's account balance via a peer-to-peer type application, such as PayPal or Venmo. The one or more servers also enable the player to cash out the player's account balance (or part of it) in any suitable manner, such as via an electronic funds transfer, by initiating creation of a paper check that is mailed to the player, or by initiating printing of a voucher at a kiosk in a gaming establishment.

In certain embodiments, the one or more servers include a payment server that handles establishing and cashing out players' account balances and a separate game server configured to determine the outcome and any associated award for a play of a game. In these embodiments, the game server is configured to communicate with the personal gaming device and the payment device, and the personal gaming device and the payment device are not configured to directly communicate with one another. In these embodiments, when the game server receives data representing a request to start a play of a game at a desired wager, the game server sends data representing the desired wager to the payment server. The payment server determines whether the player's account balance can cover the desired wager (i.e., includes a monetary balance at least equal to the desired wager).

If the payment server determines that the player's account balance cannot cover the desired wager, the payment server notifies the game server, which then instructs the personal gaming device to display a suitable notification to the player that the player's account balance is too low to place the desired wager. If the payment server determines that the player's account balance can cover the desired wager, the payment server deducts the desired wager from the account balance and notifies the game server. The game server then determines an outcome and any associated award for the play of the game. The game server notifies the payment server of any nonzero award, and the payment server increases the player's account balance by the nonzero award. The game server sends data representing the outcome and any award to the personal gaming device, which displays the outcome and any award.

In certain embodiments, the one or more servers enable web-based game play using a personal gaming device only if the personal gaming device satisfies one or more jurisdictional requirements. In one embodiment, the one or more servers enable web-based game play using the personal gaming device only if the personal gaming device is located within a designated geographic area (such as within certain state or county lines or within the boundaries of a gaming establishment). In this embodiment, the geolocation module of the personal gaming device determines the location of the personal gaming device and sends the location to the one or more servers, which determine whether the personal gaming device is located within the designated geographic area. In various embodiments, the one or more servers enable non-monetary wager-based game play if the personal gaming device is located outside of the designated geographic area.

In various embodiments, the system includes an EGM configured to communicate with a personal gaming device—such as a smartphone, a tablet computer, a desktop computer, or a laptop computer—to enable tethered mobile game play using the personal gaming device. Generally, in these embodiments, the EGM establishes communication with the personal gaming device and enables the player to play games on the EGM remotely via the personal gaming device. In certain embodiments, the system includes a geo-fence system that enables tethered game play within a particular geographic area but not outside of that geographic area.

In certain embodiments, the system is configured to communicate with a social network server that hosts or partially hosts a social networking website via a data network (such as the Internet) to integrate a player's gaming experience with the player's social networking account. This enables the system to send certain information to the social network server that the social network server can use to create content (such as text, an image, and/or a video) and post it to the player's wall, newsfeed, or similar area of the social networking website accessible by the player's connections (and in certain cases the public) such that the player's connections can view that information. This also enables the system to receive certain information from the social network server, such as the player's likes or dislikes or the player's list of connections. In certain embodiments, the system enables the player to link the player's player account to the player's social networking account(s). This enables the system to, once it identifies the player and initiates a gaming session (such as via the player logging in to a website (or an application) on the player's personal gaming device or via the player inserting the player's player tracking card into an EGM), link that gaming session to the player's social networking account(s). In other embodiments, the system enables the player to link the player's social networking account(s) to individual gaming sessions when desired by providing the required login information.

For instance, in one embodiment, if a player wins a particular award (e.g., a progressive award or a jackpot award) or an award that exceeds a certain threshold (e.g., an award exceeding $1,000), the system sends information about the award to the social network server to enable the server to create associated content (such as a screenshot of the outcome and associated award) and to post that content to the player's wall (or other suitable area) of the social networking website for the player's connections to see (and to entice them to play). In another embodiment, if a player joins a multiplayer game and there is another seat available, the system sends that information to the social network sever to enable the server to create associated content (such as text indicating a vacancy for that particular game) and to post that content to the player's wall (or other suitable area) of the social networking website for the player's connections to see (and to entice them to fill the vacancy). In another embodiment, if the player consents, the system sends advertisement information or offer information to the social network server to enable the social network server to create associated content (such as text or an image reflecting an advertisement and/or an offer) and to post that content to the player's wall (or other suitable area) of the social networking website for the player's connections to see. In another embodiment, the system enables the player to recommend a game to the player's connections by posting a recommendation to the player's wall (or other suitable area) of the social networking website.

Certain of the systems described herein, such as EGMs located in a casino or another gaming establishment, include certain components and/or are configured to operate in certain manners that differentiate these systems from general purpose computing devices, i.e., certain personal gaming devices such as desktop computers and laptop computers.

For instance, EGMs are highly regulated to ensure fairness and, in many cases, EGMs are configured to award monetary awards up to multiple millions of dollars. To satisfy security and regulatory requirements in a gaming environment, hardware and/or software architectures are implemented in EGMs that differ significantly from those of general purpose computing devices. For purposes of illustration, a description of EGMs relative to general purpose computing devices and some examples of these additional (or different) hardware and/or software architectures found in EGMs are described below.

At first glance, one might think that adapting general purpose computing device technologies to the gaming industry and EGMs would be a simple proposition because both general purpose computing devices and EGMs employ processors that control a variety of devices. However, due to at least: (1) the regulatory requirements placed on EGMs, (2) the harsh environment in which EGMs operate, (3) security requirements, and (4) fault tolerance requirements, adapting general purpose computing device technologies to EGMs can be quite difficult. Further, techniques and methods for solving a problem in the general purpose computing device industry, such as device compatibility and connectivity issues, might not be adequate in the gaming industry. For instance, a fault or a weakness tolerated in a general purpose computing device, such as security holes in software or frequent crashes, is not tolerated in an EGM because in an EGM these faults can lead to a direct loss of funds from the EGM, such as stolen cash or loss of revenue when the EGM is not operating properly or when the random outcome determination is manipulated.

Certain differences between general purpose computing devices and EGMs are described below. A first difference between EGMs and general purpose computing devices is that EGMs are state-based systems. A state-based system stores and maintains its current state in a non-volatile memory such that, in the event of a power failure or other malfunction, the state-based system can return to that state when the power is restored or the malfunction is remedied. For instance, for a state-based EGM, if the EGM displays an award for a game of chance but the power to the EGM fails before the EGM provides the award to the player, the EGM stores the pre-power failure state in a non-volatile memory, returns to that state upon restoration of power, and provides the award to the player. This requirement affects the software and hardware design on EGMs. General purpose computing devices are not state-based machines, and a majority of data is usually lost when a malfunction occurs on a general purpose computing device.

A second difference between EGMs and general purpose computing devices is that, for regulatory purposes, the software on the EGM utilized to operate the EGM has been designed to be static and monolithic to prevent cheating by the operator of the EGM. For instance, one solution that has been employed in the gaming industry to prevent cheating and to satisfy regulatory requirements has been to manufacture an EGM that can use a proprietary processor running instructions to provide the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used to operate a device during generation of the game of chance, can require burning a new EPROM approved by the gaming jurisdiction and reinstalling the new EPROM on the EGM in the presence of a gaming regulator. Regardless of whether the EPROM solution is used, to gain approval in most gaming jurisdictions, an EGM must demonstrate sufficient safeguards that prevent an operator or a player of an EGM from manipulating the EGM's hardware and software in a manner that gives him an unfair, and in some cases illegal, advantage.

A third difference between EGMs and general purpose computing devices is authentication—EGMs storing code are configured to authenticate the code to determine if the code is unaltered before executing the code. If the code has been altered, the EGM prevents the code from being executed. The code authentication requirements in the gaming industry affect both hardware and software designs on EGMs. Certain EGMs use hash functions to authenticate code. For instance, one EGM stores game program code, a hash function, and an authentication hash (which may be encrypted). Before executing the game program code, the EGM hashes the game program code using the hash function to obtain a result hash and compares the result hash to the authentication hash. If the result hash matches the authentication hash, the EGM determines that the game program code is valid and executes the game program code. If the result hash does not match the authentication hash, the EGM determines that the game program code has been altered (i.e., may have been tampered with) and prevents execution of the game program code.

A fourth difference between EGMs and general purpose computing devices is that EGMs have unique peripheral device requirements that differ from those of a general purpose computing device, such as peripheral device security requirements not usually addressed by general purpose computing devices. For instance, monetary devices, such as coin dispensers, bill validators, and ticket printers and computing devices that are used to govern the input and output of cash or other items having monetary value (such as tickets) to and from an EGM have security requirements that are not typically addressed in general purpose computing devices. Therefore, many general purpose computing device techniques and methods developed to facilitate device connectivity and device compatibility do not address the emphasis placed on security in the gaming industry.

To address some of the issues described above, a number of hardware/software components and architectures are utilized in EGMs that are not typically found in general purpose computing devices. These hardware/software components and architectures, as described below in more detail, include but are not limited to watchdog timers, voltage monitoring systems, state-based software architecture and supporting hardware, specialized communication interfaces, security monitoring, and trusted memory.

Certain EGMs use a watchdog timer to provide a software failure detection mechanism. In a normally-operating EGM, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits include a loadable timeout counter register to enable the operating software to set the timeout interval within a certain range of time. A differentiating feature of some circuits is that the operating software cannot completely disable the function of the watchdog timer. In other words, the watchdog timer always functions from the time power is applied to the board.

Certain EGMs use several power supply voltages to operate portions of the computer circuitry. These can be generated in a central power supply or locally on the computer board. If any of these voltages falls out of the tolerance limits of the circuitry they power, unpredictable operation of the EGM may result. Though most modern general purpose computing devices include voltage monitoring circuitry, these types of circuits only report voltage status to the operating software. Out of tolerance voltages can cause software malfunction, creating a potential uncontrolled condition in the general purpose computing device. Certain EGMs have power supplies with relatively tighter voltage margins than that required by the operating circuitry. In addition, the voltage monitoring circuitry implemented in certain EGMs typically has two thresholds of control. The first threshold generates a software event that can be detected by the operating software and an error condition then generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the EGM.

As described above, certain EGMs are state-based machines. Different functions of the game provided by the EGM (e.g., bet, play, result, points in the graphical presentation, etc.) may be defined as a state. When the EGM moves a game from one state to another, the EGM stores critical data regarding the game software in a custom non-volatile memory subsystem. This ensures that the player's wager and credits are preserved and to minimize potential disputes in the event of a malfunction on the EGM. In general, the EGM does not advance from a first state to a second state until critical information that enables the first state to be reconstructed has been stored. This feature enables the EGM to recover operation to the current state of play in the event of a malfunction, loss of power, etc. that occurred just before the malfunction. In at least one embodiment, the EGM is configured to store such critical information using atomic transactions.

Generally, an atomic operation in computer science refers to a set of operations that can be combined so that they appear to the rest of the system to be a single operation with only two possible outcomes: success or failure. As related to data storage, an atomic transaction may be characterized as series of database operations which either all occur, or all do not occur. A guarantee of atomicity prevents updates to the database occurring only partially, which can result in data corruption.

To ensure the success of atomic transactions relating to critical information to be stored in the EGM memory before a failure event (e.g., malfunction, loss of power, etc.), memory that includes one or more of the following criteria be used: direct memory access capability; data read/write capability which meets or exceeds minimum read/write access characteristics (such as at least 5.08 Mbytes/sec (Read) and/or at least 38.0 Mbytes/sec (Write)). Memory devices that meet or exceed the above criteria may be referred to as “fault-tolerant” memory devices.

Typically, battery-backed RAM devices may be configured to function as fault-tolerant devices according to the above criteria, whereas flash RAM and/or disk drive memory are typically not configurable to function as fault-tolerant devices according to the above criteria. Accordingly, battery-backed RAM devices are typically used to preserve EGM critical data, although other types of non-volatile memory devices may be employed. These memory devices are typically not used in typical general purpose computing devices.

Thus, in at least one embodiment, the EGM is configured to store critical information in fault-tolerant memory (e.g., battery-backed RAM devices) using atomic transactions. Further, in at least one embodiment, the fault-tolerant memory is able to successfully complete all desired atomic transactions (e.g., relating to the storage of EGM critical information) within a time period of 200 milliseconds or less. In at least one embodiment, the time period of 200 milliseconds represents a maximum amount of time for which sufficient power may be available to the various EGM components after a power outage event has occurred at the EGM.

As described previously, the EGM may not advance from a first state to a second state until critical information that enables the first state to be reconstructed has been atomically stored. After the state of the EGM is restored during the play of a game of chance, game play may resume and the game may be completed in a manner that is no different than if the malfunction had not occurred. Thus, for example, when a malfunction occurs during a game of chance, the EGM may be restored to a state in the game of chance just before when the malfunction occurred. The restored state may include metering information and graphical information that was displayed on the EGM in the state before the malfunction. For example, when the malfunction occurs during the play of a card game after the cards have been dealt, the EGM may be restored with the cards that were previously displayed as part of the card game. As another example, a bonus game may be triggered during the play of a game of chance in which a player is required to make a number of selections on a video display screen. When a malfunction has occurred after the player has made one or more selections, the EGM may be restored to a state that shows the graphical presentation just before the malfunction including an indication of selections that have already been made by the player. In general, the EGM may be restored to any state in a plurality of states that occur in the game of chance that occurs while the game of chance is played or to states that occur between the play of a game of chance.

Game history information regarding previous games played such as an amount wagered, the outcome of the game, and the like may also be stored in a non-volatile memory device. The information stored in the non-volatile memory may be detailed enough to reconstruct a portion of the graphical presentation that was previously presented on the EGM and the state of the EGM (e.g., credits) at the time the game of chance was played. The game history information may be utilized in the event of a dispute. For example, a player may decide that in a previous game of chance that they did not receive credit for an award that they believed they won. The game history information may be used to reconstruct the state of the EGM before, during, and/or after the disputed game to demonstrate whether the player was correct or not in the player's assertion.

Another feature of EGMs is that they often include unique interfaces, including serial interfaces, to connect to specific subsystems internal and external to the EGM. The serial devices may have electrical interface requirements that differ from the “standard” EIA serial interfaces provided by general purpose computing devices. These interfaces may include, for example, Fiber Optic Serial, optically coupled serial interfaces, current loop style serial interfaces, etc. In addition, to conserve serial interfaces internally in the EGM, serial devices may be connected in a shared, daisy-chain fashion in which multiple peripheral devices are connected to a single serial channel.

The serial interfaces may be used to transmit information using communication protocols that are unique to the gaming industry. For example, IGT's Netplex is a proprietary communication protocol used for serial communication between EGMs. As another example, SAS is a communication protocol used to transmit information, such as metering information, from an EGM to a remote device. Often SAS is used in conjunction with a player tracking system.

Certain EGMs may alternatively be treated as peripheral devices to a casino communication controller and connected in a shared daisy chain fashion to a single serial interface. In both cases, the peripheral devices are assigned device addresses. If so, the serial controller circuitry must implement a method to generate or detect unique device addresses. General purpose computing device serial ports are not able to do this.

Security monitoring circuits detect intrusion into an EGM by monitoring security switches attached to access doors in the EGM cabinet. Access violations result in suspension of game play and can trigger additional security operations to preserve the current state of game play. These circuits also function when power is off by use of a battery backup. In power-off operation, these circuits continue to monitor the access doors of the EGM. When power is restored, the EGM can determine whether any security violations occurred while power was off, e.g., via software for reading status registers. This can trigger event log entries and further data authentication operations by the EGM software.

Trusted memory devices and/or trusted memory sources are included in an EGM to ensure the authenticity of the software that may be stored on less secure memory subsystems, such as mass storage devices. Trusted memory devices and controlling circuitry are typically designed to not enable modification of the code and data stored in the memory device while the memory device is installed in the EGM. The code and data stored in these devices may include authentication algorithms, random number generators, authentication keys, operating system kernels, etc. The purpose of these trusted memory devices is to provide gaming regulatory authorities a root trusted authority within the computing environment of the EGM that can be tracked and verified as original. This may be accomplished via removal of the trusted memory device from the EGM computer and verification of the secure memory device contents is a separate third party verification device. Once the trusted memory device is verified as authentic, and based on the approval of the verification algorithms included in the trusted device, the EGM is enabled to verify the authenticity of additional code and data that may be located in the gaming computer assembly, such as code and data stored on hard disk drives.

In at least one embodiment, at least a portion of the trusted memory devices/sources may correspond to memory that cannot easily be altered (e.g., “unalterable memory”) such as EPROMS, PROMS, Bios, Extended Bios, and/or other memory sources that are able to be configured, verified, and/or authenticated (e.g., for authenticity) in a secure and controlled manner.

According to one embodiment, when a trusted information source is in communication with a remote device via a network, the remote device may employ a verification scheme to verify the identity of the trusted information source. For example, the trusted information source and the remote device may exchange information using public and private encryption keys to verify each other's identities. In another embodiment, the remote device and the trusted information source may engage in methods using zero knowledge proofs to authenticate each of their respective identities.

EGMs storing trusted information may utilize apparatuses or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

Mass storage devices used in a general purpose computing devices typically enable code and data to be read from and written to the mass storage device. In a gaming environment, modification of the gaming code stored on a mass storage device is strictly controlled and would only be enabled under specific maintenance type events with electronic and physical enablers required. Though this level of security could be provided by software, EGMs that include mass storage devices include hardware level mass storage data protection circuitry that operates at the circuit level to monitor attempts to modify data on the mass storage device and will generate both software and hardware error triggers should a data modification be attempted without the proper electronic and physical enablers being present.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary, a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention claimed is:

1. A system comprising:
a processor; and
a memory device that stores a plurality of instructions that, when executed by the processor, cause the processor to:
responsive to each of an occurrence of a ticket voucher redemption award opportunity event associated with a ticket voucher received at a ticket voucher redemption kiosk and an occurrence of a ticket voucher redemption contribution event:
cause the ticket voucher to be designated as redeemed,
cause, based on at least part of an amount of the ticket voucher, a modification of an amount of a contribution pool, and
responsive to an occurrence of an award triggering event associated with the designation of the ticket voucher as redeemed, determine, based on the modified amount of the contribution pool, a prize to be made available.

2. The system of claim 1, wherein the determination of the prize is further based on an input received via an input device.

3. The system of claim 1, wherein the determination of the prize is further based an identity of a user of the ticket voucher redemption kiosk.

4. The system of claim 1, wherein the memory device stores a plurality of further instructions that, when executed by the processor responsive to the occurrence of the award triggering event, cause the processor to cause the prize to be associated with a gaming establishment account of a user of the ticket voucher redemption kiosk.

5. The system of claim 1, wherein the memory device stores a plurality of further instructions that, when executed by the processor responsive to the occurrence of the award triggering event, cause the processor to cause the ticket voucher redemption kiosk to issue another ticket voucher redeemable for the prize.

6. The system of claim 1, wherein the ticket voucher redemption award opportunity event occurs based on the amount of the ticket voucher being less than a threshold amount.

7. The system of claim 1, wherein a probability of the award triggering event occurring is based on the amount of the ticket voucher.

8. The system of claim 1, wherein the memory device stores a plurality of further instructions that, when executed by the processor responsive to an occurrence of a credit meter cashout award opportunity event associated with an input received at a gaming device and an occurrence of a credit meter cashout contribution event, cause the processor to modify, based on at least part of an amount of a credit meter of the gaming device, the amount of the contribution pool.

9. A system comprising:
a processor; and
a memory device that stores a plurality of instructions that, when executed by the processor responsive to each of a cashout input being received at a gaming device, an occurrence of a credit meter cashout award opportunity event and an occurrence of a credit meter cashout contribution event, cause the processor to:
communicate data that causes the gaming device to reduce an amount of a credit meter without issuing any ticket vouchers in association with the cashout input received,
modify, based on at least part of the reduced amount of the credit meter, an amount of a contribution pool, and
responsive to an occurrence of an award triggering event, determine, based on the modified amount of the contribution pool, a prize to be made available.

10. The system of claim 9, wherein the occurrence of the credit meter cashout award opportunity event is based on the amount of the credit meter being less than a threshold amount.

11. The system of claim 9, wherein the determination of the prize is further based on at least one of an input received via an input device and an identity of a user of the gaming device.

12. The system of claim 9, wherein the memory device stores a plurality of further instructions that, when executed by the processor responsive to the occurrence of the award triggering event, cause the processor to cause at least one of the prize to be associated with a gaming establishment account of a user of the gaming device and cause the gaming device to issue a ticket voucher redeemable for the prize.

13. A method of operating a system, the method comprising:
responsive to each of an occurrence of a ticket voucher redemption award opportunity event associated with a ticket voucher received at a ticket voucher redemption kiosk and an occurrence of a ticket voucher redemption contribution event:
causing, by a processor, the ticket voucher to be designated as redeemed,
causing, by the processor and based on at least part of an amount of the ticket voucher, a modification of an amount of a contribution pool, and
responsive to an occurrence of an award triggering event associated with the designation of the ticket voucher as redeemed, determining, by the processor and based on the modified amount of the contribution pool, a prize to be made available.

14. The method of claim 13, wherein the determination of the prize is further based on an input received via an input device.

15. The method of claim 13, wherein the determination of the prize is further based an identity of a user of the ticket voucher redemption kiosk.

16. The method of claim 13, further comprising, responsive to the occurrence of the award triggering event, causing, by the processor, the prize to be associated with a gaming establishment account of a user of the ticket voucher redemption kiosk.

17. The method of claim 13, further comprising, responsive to the occurrence of the award triggering event, causing, by the processor, the ticket voucher redemption kiosk to issue another ticket voucher redeemable for the prize.

18. The method of claim 13, wherein the ticket voucher redemption award opportunity event occurs based on the amount of the ticket voucher being less than a threshold amount.

19. The method of claim 13, wherein a probability of the award triggering event occurring is based on the amount of the ticket voucher.

20. The method of claim 13, further comprising, responsive to an occurrence of a credit meter cashout award opportunity event associated with an input received at a gaming device and an occurrence of a credit meter cashout contribution event, modifying, by the processor and based on at least part of an amount of a credit meter of the gaming device, the amount of the contribution pool.
